SEQUENCE LISTING (337 sequences)

SEQ ID NO: 1 - protein, 13 aa, Homo sapiens
RLDGENIYIRHSN

SEQ ID NO: 2 - protein, 13 aa, Homo sapiens
WGRGTDEYFIRKP

SEQ ID NO: 3 - protein, 13 aa, Homo sapiens
YISKAEEYFLLKS

SEQ ID NO: 4 - protein, 13 aa, Homo sapiens
EREGSKRYCIQTK

SEQ ID NO: 5 - protein, 13 aa, Homo sapiens
IENEEQEYVQTVK

SEQ ID NO: 6 - protein, 13 aa, Homo sapiens
HSTPPSAYGSVKA

SEQ ID NO: 7 - protein, 13 aa, Homo sapiens
TEATATDYHTTSH

SEQ ID NO: 8 - protein, 13 aa, Homo sapiens
TEASGYISSLEYP

SEQ ID NO: 9 - protein, 13 aa, Homo sapiens
FDKDGNGYISAAE

SEQ ID NO: 10 - protein, 13 aa, Homo sapiens
KDGNGYISAAELR

SEQ ID NO: 11 - protein, 13 aa, Homo sapiens
EGEEDTEYMTPSS

SEQ ID NO: 12 - protein, 13 aa, Homo sapiens
STATKDTYDALHM

SEQ ID NO: 13 - protein, 13 aa, Homo sapiens
EYEDENLYEGLNL

SEQ ID NO: 14 - protein, 13 aa, Homo sapiens
EKIGEGTYGVVYK

SEQ ID NO: 15 - protein, 13 aa, Homo sapiens
GLAKSFGSPNRAY

SEQ ID NO: 16 - protein, 13 aa, Homo sapiens
QKRREILSRRPSY

SEQ ID NO: 17 - protein, 13 aa, Homo sapiens
GPPEPGPYAQPSV

SEQ ID NO: 18 - protein, 13 aa, Homo sapiens
VADIDGQYAMTRA

SEQ ID NO: 19 - protein, 13 aa, Homo sapiens
GIVYAVSSDRFRS

SEQ ID NO: 20 - protein, 13 aa, Homo sapiens
LLLSNPAYRLLLA

SEQ ID NO: 21 - protein, 13 aa, Homo sapiens
FGMSRNLYAGDYY

SEQ ID NO: 22 - protein, 13 aa, Homo sapiens
RNLYSGDYYRIQG

SEQ ID NO: 23 - protein, 13 aa, Homo sapiens
KHDTEMKYYIVHL

SEQ ID NO: 24 - protein, 13 aa, Homo sapiens
CQLGQRIYQYIQS

SEQ ID NO: 25 - protein, 13 aa, Homo sapiens
GGTDEGIYDVPLL

SEQ ID NO: 26 - protein, 13 aa, Homo sapiens
GGTDEGIFDVPLL

SEQ ID NO: 27 - protein, 13 aa, Homo sapiens
EDSFLQRYSSDPT

SEQ ID NO: 28 - protein, 13 aa, Homo sapiens
GSVQNPVYHNQPL

SEQ ID NO: 29 - protein, 13 aa, Homo sapiens
APSRDPHYQDPHS

SEQ ID NO: 30 - protein, 13 aa, Homo sapiens
ISLDNPDYQQDFF

SEQ ID NO: 31 - protein, 13 aa, Homo sapiens
STAENAEYLRVAP

SEQ ID NO: 32 - protein, 13 aa, Homo sapiens
LGAEEKEYHAEGG

SEQ ID NO: 33 - protein, 13 aa, Homo sapiens
MTFGSKPYDGIPA

SEQ ID NO: 34 - protein, 13 aa, Homo sapiens
SGASTGIYEALEL

SEQ ID NO: 35 - protein, 13 aa, Homo sapiens
LDDFDGTYETQGG

SEQ ID NO: 36 - protein, 13 aa, Homo sapiens
QLKPLKTYVDPHT

SEQ ID NO: 37 - protein, 13 aa, Homo sapiens
EDDPEATYTTSGG

SEQ ID NO: 38 - protein, 13 aa, Homo sapiens
LNQGVRTYVDPFT

SEQ ID NO: 39 - protein, 13 aa, Homo sapiens
QAIKMDRYKDNFT

SEQ ID NO: 40 - protein, 13 aa, Homo sapiens
TYIDPETYEDPNR

SEQ ID NO: 41 - protein, 13 aa, Homo sapiens
DDTSDPTYTSSLG

SEQ ID NO: 42 - protein, 13 aa, Homo sapiens
SAIKMVQYRDSFL

SEQ ID NO: 43 - protein, 13 aa, Homo sapiens
IGHGTKVYIDPFT

SEQ ID NO: 44 - protein, 13 aa, Homo sapiens
SEHAQDTYLVLDK

SEQ ID NO: 45 - protein, 13 aa, Homo sapiens
ASAASFEYTILDP

SEQ ID NO: 46 - protein, 13 aa, Homo sapiens
PTAENPEYLGLDV

SEQ ID NO: 47 - protein, 13 aa, Homo sapiens
LDIDETEYHADGG

SEQ ID NO: 48 - protein, 13 aa, Homo sapiens
PISTIDVYMIMVK

SEQ ID NO: 49 - protein, 13 aa, Homo sapiens
QALDNPEYHNASN

SEQ ID NO: 50 - protein, 13 aa, Homo sapiens
IVAENPEYLSEFS

SEQ ID NO: 51 - protein, 13 aa, Homo sapiens
RLQRRRGSSIPQF

SEQ ID NO: 52 - protein, 13 aa, Homo sapiens
DSKNFDDYMKSLG

SEQ ID NO: 53 - protein, 13 aa, Homo sapiens
RYMEDSTYYKASK

SEQ ID NO: 54 - protein, 13 aa, Homo sapiens
RYIEDEDYYKASV

SEQ ID NO: 55 - protein, 13 aa, Homo sapiens
RQEDGGVYSSSGL

SEQ ID NO: 56 - protein, 13 aa, Homo sapiens
REEADGVYAASGG

SEQ ID NO: 57 - protein, 13 aa, Homo sapiens
ALTSNQEYLDLSM

SEQ ID NO: 58 - protein, 13 aa, Homo sapiens
TLTTNEEYLDLSQ

SEQ ID NO: 59 - protein, 13 aa, Homo sapiens
DVHNLDYYKKTTN

SEQ ID NO: 60 - protein, 13 aa, Homo sapiens
TVTSTDEYLDLSA

SEQ ID NO: 61 - protein, 13 aa, Homo sapiens
KVDNEDIYESRHE

SEQ ID NO: 62 - protein, 13 aa, Homo sapiens
RGEPNVSYICSRY

SEQ ID NO: 63 - protein, 13 aa, Homo sapiens
DGKKRKRSRKESY

SEQ ID NO: 64 - protein, 13 aa, Homo sapiens
SLGFKRSYEEHIP

SEQ ID NO: 65 - protein, 13 aa, Homo sapiens
YASSNPEYLSASD

SEQ ID NO: 66 - protein, 13 aa, Homo sapiens
SSEDLSAYASISF

SEQ ID NO: 67 - protein, 13 aa, Homo sapiens
GGGGGEFYGYMTM

SEQ ID NO: 68 - protein, 13 aa, Homo sapiens
AIETDKEYYTVKD

SEQ ID NO: 69 - protein, 13 aa, Homo sapiens
GAGFGSRSLYGLG

SEQ ID NO: 70 - protein, 13 aa, Homo sapiens
SAYGGLTSPGLSY

SEQ ID NO: 71 - protein, 13 aa, Homo sapiens
ALRADENYYKAQT

SEQ ID NO: 72 - protein, 13 aa, Homo sapiens
MESIDDYVNVPES

SEQ ID NO: 73 - protein, 13 aa, Homo sapiens
EEGAPDYENLQEL

SEQ ID NO: 74 - protein, 13 aa, Homo sapiens
RLIEDNEYTAREG

SEQ ID NO: 75 - protein, 13 aa, Homo sapiens
RDIYRASYYRRGD

SEQ ID NO: 76 - protein, 13 aa, Homo sapiens
ARTAHYGSLPQKS

SEQ ID NO: 77 - protein, 13 aa, Homo sapiens
FGYGGRASDYKSA

SEQ ID NO: 78 - protein, 13 aa, Homo sapiens
GRASDYKSAHKGF

SEQ ID NO: 79 - protein, 13 aa, Homo sapiens
RDMYDKEYYSVHN

SEQ ID NO: 80 - protein, 13 aa, Homo sapiens
HTGFLTEYVATRW

SEQ ID NO: 81 - protein, 13 aa, Homo sapiens
IMLNSKGYTKSID

SEQ ID NO: 82 - protein, 13 aa, Homo sapiens
AEHQYFMTEYVAT

SEQ ID NO: 83 - protein, 13 aa, Homo sapiens
TSFMMTPYVVTRY

SEQ ID NO: 84 - protein, 13 aa, Homo sapiens
ADSEMTGYVVTRW

SEQ ID NO: 85 - protein, 13 aa, Homo sapiens
RHTDDEMTGYVAT

SEQ ID NO: 86 - protein, 13 aa, Homo sapiens
QRSRKRLSQDAYR

SEQ ID NO: 87 - protein, 13 aa, Homo sapiens
AKALGKRTAKYRW

SEQ ID NO: 88 - protein, 13 aa, Homo sapiens
HIIENPQYFSDAC

SEQ ID NO: 89 - protein, 13 aa, Homo sapiens
PVIENPQYFGITN

SEQ ID NO: 90 - protein, 13 aa, Homo sapiens
FGMSRDVYSTDYY

SEQ ID NO: 91 - protein, 13 aa, Homo sapiens
RDVYSTDYYRVGG

SEQ ID NO: 92 - protein, 13 aa, Homo sapiens
DDSSAYRSVDEVN

SEQ ID NO: 93 - protein, 13 aa, Homo sapiens
SMSDPGVSYRTRE

SEQ ID NO: 94 - protein, 13 aa, Homo sapiens
EPHVTRRTPDYFL

SEQ ID NO: 95 - protein, 13 aa, Homo sapiens
NENTEDQYSLVED

SEQ ID NO: 96 - protein, 13 aa, Homo sapiens
VGEEEHVYSFPNK

SEQ ID NO: 97 - protein, 13 aa, Homo sapiens
FLSEETPYSYPTG

SEQ ID NO: 98 - protein, 13 aa, Homo sapiens
ARTTSQLYDAVPI

SEQ ID NO: 99 - protein, 13 aa, Homo sapiens
DEDCYGNYDNLLS

SEQ ID NO: 100 - protein, 13 aa, Homo sapiens
KKDTETVYSEVRK

SEQ ID NO: 101 - protein, 13 aa, Homo sapiens
QRSELDKSSAHSY

SEQ ID NO: 102 - protein, 13 aa, Homo sapiens
LDTSSVLYTAVQP

SEQ ID NO: 103 - protein, 13 aa, Homo sapiens
VSSDGHEYIYVDP

SEQ ID NO: 104 - protein, 13 aa, Homo sapiens
RPPSAELYSNALP

SEQ ID NO: 105 - protein, 13 aa, Homo sapiens
SSNYMAPYDNYVP

SEQ ID NO: 106 - protein, 13 aa, Homo sapiens
YMAPYDNYVPSAP

SEQ ID NO: 107 - protein, 13 aa, Homo sapiens
EGSFESRYQQPFE

SEQ ID NO: 108 - protein, 13 aa, Homo sapiens
IGTAEPDYGALYE

SEQ ID NO: 109 - protein, 13 aa, Homo sapiens
EGRNPGFYVEANP

SEQ ID NO: 110 - protein, 13 aa, Homo sapiens
WTASSPYSTVPPY

SEQ ID NO: 111 - protein, 13 aa, Homo sapiens
SKRKGHEYTNIKY

SEQ ID NO: 112 - protein, 13 aa, Homo sapiens
RPRGQRDSSYYWE

SEQ ID NO: 113 - protein, 13 aa, Homo sapiens
TVDGKEIYNTIRR

SEQ ID NO: 114 - protein, 13 aa, Homo sapiens
IYISPLKSPYKIS

SEQ ID NO: 115 - protein, 13 aa, Homo sapiens
VPTVSKGTVEGNY

SEQ ID NO: 116 - protein, 13 aa, Homo sapiens
TPSDSLIYDDGLS

SEQ ID NO: 117 - protein, 13 aa, Homo sapiens
AQAFPVSYSSSGA

SEQ ID NO: 118 - protein, 13 aa, Homo sapiens
SALLGDHYVQLPA

SEQ ID NO: 119 - protein, 13 aa, Homo sapiens
YVQLPATYMNLGP

SEQ ID NO: 120 - protein, 13 aa, Homo sapiens
VSQREAEYEPETV

SEQ ID NO: 121 - protein, 13 aa, Homo sapiens
EYEPETVYEVAGA

SEQ ID NO: 122 - protein, 13 aa, Homo sapiens
YQAEENTYDEYEN

SEQ ID NO: 123 - protein, 13 aa, Homo sapiens
LAKAVDGYVKPQI

SEQ ID NO: 124 - protein, 13 aa, Homo sapiens
DGPKGTGYIKTEL

SEQ ID NO: 125 - protein, 13 aa, Homo sapiens
NLQERRKYLKHRL

SEQ ID NO: 126 - protein, 13 aa, Homo sapiens
DPGSAAPYLKTKF

SEQ ID NO: 127 - protein, 13 aa, Homo sapiens
TERGDKGYVPSVF

SEQ ID NO: 128 - protein, 13 aa, Homo sapiens
PSDLLPMSPSVYA

SEQ ID NO: 129 - protein, 13 aa, Homo sapiens
NYLRRRLSDSNFM

SEQ ID NO: 130 - protein, 13 aa, Homo sapiens
SGYSSPGSPGTPG

SEQ ID NO: 131 - protein, 13 aa, Homo sapiens
RYFLDDQYTSSSG

SEQ ID NO: 132 - protein, 13 aa, Homo sapiens
SDTEEQEYEEEQP

SEQ ID NO: 133 - protein, 13 aa, Homo sapiens
KIYSGDYYRQGCA

SEQ ID NO: 134 - protein, 13 aa, Homo sapiens
KNPDYVRKGDTRL

SEQ ID NO: 135 - protein, 13 aa, Homo sapiens
DIYKDPDYVRKGD

SEQ ID NO: 136 - protein, 13 aa, Homo sapiens
RFRQGKDYVGAIP

SEQ ID NO: 137 - protein, 13 aa, Homo sapiens
DIYKDPDYVRKGS

SEQ ID NO: 138 - protein, 13 aa, Homo sapiens
KSFLDSGYRILGA

SEQ ID NO: 139 - protein, 13 aa, Homo sapiens
ALGADDSYYTARS

SEQ ID NO: 140 - protein, 13 aa, Homo sapiens
LRTHNGASPYQCT

SEQ ID NO: 141 - protein, 15 aa, Homo sapiens
HKLGGGQYGEVYEGV

SEQ ID NO: 142 - protein, 15 aa, Homo sapiens
RTSSESIYSRPGSSI

SEQ ID NO: 143 - protein, 15 aa, Homo sapiens
GSINSPVYSRHSYTP

SEQ ID NO: 144 - protein, 15 aa, Homo sapiens
SRTTDGVYEGVAIGG

SEQ ID NO: 145 - protein, 15 aa, Homo sapiens
VTHTVPIYEGYALPH

SEQ ID NO: 146 - protein, 15 aa, Homo sapiens
PARPAPAPPLYSSLT

SEQ ID NO: 147 - protein, 15 aa, Homo sapiens
PNQFVPLYTDPQEVL

SEQ ID NO: 148 - protein, 15 aa, Homo sapiens
KQTIPDPYEDFMYRH

SEQ ID NO: 149 - protein, 15 aa, Homo sapiens
RKNLEATYGTVRTGN

SEQ ID NO: 150 - protein, 15 aa, Homo sapiens
DQDARDLYDAGVKRK

SEQ ID NO: 151 - protein, 15 aa, Homo sapiens
RYKSYSPYDMLESIR

SEQ ID NO: 152 - protein, 15 aa, Homo sapiens
FKAYQFYYGSNRCTN

SEQ ID NO: 153 - protein, 15 aa, Homo sapiens
SKMQQNGYENPTYKF

SEQ ID NO: 154 - protein, 15 aa, Homo sapiens
ALEEDVIYDDVPCES

SEQ ID NO: 155 - protein, 15 aa, Homo sapiens
YQTHQPVYHKIQGDD

SEQ ID NO: 156 - protein, 15 aa, Homo sapiens
APGPQDIYDVPPVRG

SEQ ID NO: 157 - protein, 15 aa, Homo sapiens
PLLREETYDVPPAFA

SEQ ID NO: 158 - protein, 15 aa, Homo sapiens
SPPAEDVYDVPPPAP

SEQ ID NO: 159 - protein, 15 aa, Homo sapiens
PPPAPDLYDVPPGLR

SEQ ID NO: 160 - protein, 15 aa, Homo sapiens
EGGWMEDYDYVHLQG

SEQ ID NO: 161 - protein, 15 aa, Homo sapiens
RPGPGTLYDVPRERV

SEQ ID NO: 162 - protein, 15 aa, Homo sapiens
SCGVDGDYEDAELNP

SEQ ID NO: 163 - protein, 15 aa, Homo sapiens
WNSVARRYPNLFTNM

SEQ ID NO: 164 - protein, 15 aa, Homo sapiens
EDEGWQVYRLGARDA

SEQ ID NO: 165 - protein, 15 aa, Homo sapiens
VKSLEDPYSQQIRLQ

SEQ ID NO: 166 - protein, 15 aa, Homo sapiens
CPFIDNTYSCSGKLL

SEQ ID NO: 167 - protein, 15 aa, Homo sapiens
DESQGEIYRSIEHLD

SEQ ID NO: 168 - protein, 15 aa, Homo sapiens
RAYADSYYYEDGGMK

SEQ ID NO: 169 - protein, 15 aa, Homo sapiens
TDGEDADYTHFTNQQ

SEQ ID NO: 170 - protein, 15 aa, Homo sapiens
APGGRHPGGGDYEEL

SEQ ID NO: 171 - protein, 15 aa, Homo sapiens
TTQNGRFYAISARFK

SEQ ID NO: 172 - protein, 15 aa, Homo sapiens
VDSEGHLYTVPIREQ

SEQ ID NO: 173 - protein, 15 aa, Homo sapiens
SSSANAIYSLAARPL

SEQ ID NO: 174 - protein, 15 aa, Homo sapiens
TNRTSQDYDQLPSCS

SEQ ID NO: 175 - protein, 15 aa, Homo sapiens
EGTYGVVYKAKNRET

SEQ ID NO: 176 - protein, 15 aa, Homo sapiens
MRESEGLYGQPGDET

SEQ ID NO: 177 - protein, 15 aa, Homo sapiens
GQTVDDPYATFVKML

SEQ ID NO: 178 - protein, 15 aa, Homo sapiens
RPYPKPAPSSGKDYV

SEQ ID NO: 179 - protein, 15 aa, Homo sapiens
SQRNRSNYYDAYQAQ

SEQ ID NO: 180 - protein, 15 aa, Homo sapiens
SRHYEDGYPGGSDNY

SEQ ID NO: 181 - protein, 15 aa, Homo sapiens
RLPSSPVYEDAASFK

SEQ ID NO: 182 - protein, 15 aa, Homo sapiens
EGTYGVVYKGRHKTT

SEQ ID NO: 183 - protein, 15 aa, Homo sapiens
KKKTEGTYDLPYWDR

SEQ ID NO: 184 - protein, 15 aa, Homo sapiens
PAPDELVYQVPQSTQ

SEQ ID NO: 185 - protein, 15 aa, Homo sapiens
RYGRRKQYPISLVLA

SEQ ID NO: 186 - protein, 15 aa, Homo sapiens
RLKSTCIYGGAPKGP

SEQ ID NO: 187 - protein, 15 aa, Homo sapiens
RVSTDLKYRKQPWGL

SEQ ID NO: 188 - protein, 15 aa, Homo sapiens
ATQPEPIYAESTKRK

SEQ ID NO: 189 - protein, 15 aa, Homo sapiens
CPSQDSLYSDPLDST

SEQ ID NO: 190 - protein, 15 aa, Homo sapiens
YNPATDDYAVPPPRS

SEQ ID NO: 191 - protein, 15 aa, Homo sapiens
ENNYCPHYEKVSGDY

SEQ ID NO: 192 - protein, 15 aa, Homo sapiens
TLDTLSIYETPSMGL

SEQ ID NO: 193 - protein, 15 aa, Homo sapiens
WSLPNPEYYTLRYAD

SEQ ID NO: 194 - protein, 15 aa, Homo sapiens
IPKEPSSYDFVYHYG

SEQ ID NO: 195 - skipped

SEQ ID NO: 196 - protein, 15 aa, Homo sapiens
DDTSDPTYTSALGGK

SEQ ID NO: 197 - protein, 15 aa, Homo sapiens
VYIDPFTYEDPNEAV

SEQ ID NO: 198 - protein, 15 aa, Homo sapiens
ENSSDPTYTSSLGGK

SEQ ID NO: 199 - protein, 15 aa, Homo sapiens
PTAENPEYLGLDVPV

SEQ ID NO: 200 - protein, 15 aa, Homo sapiens
EEEDVNGYVMPDTHL

SEQ ID NO: 201 - protein, 15 aa, Homo sapiens
KVSSTHYYLLPERPP

SEQ ID NO: 202 - protein, 15 aa, Homo sapiens
TSSKKVIYSQPSARS

SEQ ID NO: 203 - protein, 15 aa, Homo sapiens
IIDEEDTYTMPSTRD

SEQ ID NO: 204 - protein, 15 aa, Homo sapiens
PIGNQHIYQPVGKPD

SEQ ID NO: 205 - protein, 15 aa, Homo sapiens
DRSNDKVYENVTGLV

SEQ ID NO: 206 - protein, 15 aa, Homo sapiens
EYENIRHYEEIPEYE

SEQ ID NO: 207 - protein, 15 aa, Homo sapiens
GTGEDDDYVDDFNST

SEQ ID NO: 208 - protein, 10 aa, Homo sapiens
EFGTYGTLSK

SEQ ID NO: 209 - protein, 15 aa, Homo sapiens
GDVSQFPYVEFTGRD

SEQ ID NO: 210 - protein, 15 aa, Homo sapiens
RHGEQSLYSPQTPAY

SEQ ID NO: 211 - protein, 15 aa, Homo sapiens
LNGAEPNYHSLPSAR

SEQ ID NO: 212 - protein, 15 aa, Homo sapiens
PPDYNSVVLYSTPPI

SEQ ID NO: 213 - protein, 15 aa, Homo sapiens
RKLDNGGYYITTRAQ

SEQ ID NO: 214 - protein, 15 aa, Homo sapiens
ASVDSSLYNLPRSYS

SEQ ID NO: 215 - protein, 15 aa, Homo sapiens
QQNTDLIYQTGPKST

SEQ ID NO: 216 - protein, 15 aa, Homo sapiens
KVPSEGAYDIILPRA

SEQ ID NO: 217 - protein, 15 aa, Homo sapiens
DGFDPSDYAEPMDAV

SEQ ID NO: 218 - protein, 15 aa, Homo sapiens
PQGPPEIYSDTQFPS

SEQ ID NO: 219 - protein, 15 aa, Homo sapiens
KSEVDETYALPATKI

SEQ ID NO: 220 - protein, 15 aa, Homo sapiens
RVIEDNEYTAREGAK

SEQ ID NO: 221 - protein, 11 aa, Homo sapiens
AAEEIYAARRG

SEQ ID NO: 222 - protein, 15 aa, Homo sapiens
SRNMGGPYGGGNYGP

SEQ ID NO: 223 - protein, 15 aa, Homo sapiens
KATENDIYNFFSPLN

SEQ ID NO: 224 - protein, 15 aa, Homo sapiens
GMDNQGGYGSVGRMG

SEQ ID NO: 225 - protein, 15 aa, Homo sapiens
GQRQALDYVELSPLT

SEQ ID NO: 226 - protein, 15 aa, Homo sapiens
STSPESPYTHWKQTV

SEQ ID NO: 227 - protein, 15 aa, Homo sapiens
DDITQEEYGEFYKSL

SEQ ID NO: 228 - protein, 15 aa, Homo sapiens
KETQKSIYYITGESK

SEQ ID NO: 229 - protein, 15 aa, Homo sapiens
QSYNQSPYSNYGPPQ

SEQ ID NO: 230 - protein, 15 aa, Homo sapiens
DIYETDYYRKGGKGL

SEQ ID NO: 231 - protein, 15 aa, Homo sapiens
QRVDPNGYMMMSPSG

SEQ ID NO: 232 - protein, 15 aa, Homo sapiens
CGGDSDQYVLMSSPV

SEQ ID NO: 233 - protein, 15 aa, Homo sapiens
GAQGEGPYSSLVSCR

SEQ ID NO: 234 - protein, 15 aa, Homo sapiens
REEPEALYAAVNKKP

SEQ ID NO: 235 - protein, 15 aa, Homo sapiens
VRREVGDYGQLHETE

SEQ ID NO: 236 - protein, 15 aa, Homo sapiens
DIYKDPDYVRKGDAR

SEQ ID NO: 237 - protein, 15 aa, Homo sapiens
EEAPEDLYKDFLTLE

SEQ ID NO: 238 - protein, 15 aa, Homo sapiens
PNPCSATYSNLGQSR

SEQ ID NO: 239 - protein, 15 aa, Homo sapiens
AYDNLAIYKSFLGTS

SEQ ID NO: 240 - protein, 15 aa, Homo sapiens
TRVMKAIYSSFKDDV

SEQ ID NO: 241 - protein, 15 aa, Homo sapiens
SGLERTPYEAYDPIG

SEQ ID NO: 242 - protein, 15 aa, Homo sapiens
DHAEAALYKNLLHSK

SEQ ID NO: 243 - protein, 15 aa, Homo sapiens
CSDSTNEYMDMKPGV

SEQ ID NO: 244 - protein, 15 aa, Homo sapiens
SESTNHIYSNLANCS

SEQ ID NO: 245 - protein, 15 aa, Homo sapiens
SGGYGGGYGGVLTAS

SEQ ID NO: 246 - protein, 15 aa, Homo sapiens
EDEESEDYQNSASIH

SEQ ID NO: 247 - protein, 15 aa, Homo sapiens
KMVVESAYEVIKLKG

SEQ ID NO: 248 - protein, 15 aa, Homo sapiens
SIYAPSTYAHLSPAK

SEQ ID NO: 249 - protein, 15 aa, Homo sapiens
KVGCFDPYSDDPRLG

SEQ ID NO: 250 - protein, 15 aa, Homo sapiens
RSWASPVYTEADGTF

SEQ ID NO: 251 - protein, 15 aa, Homo sapiens
IDATSGIYNSEKSSN

SEQ ID NO: 252 - protein, 15 aa, Homo sapiens
RSENEDIYYKSMPNL

SEQ ID NO: 253 - protein, 15 aa, Homo sapiens
RGGMDYAYIPPPGLQ

SEQ ID NO: 254 - protein, 15 aa, Homo sapiens
GRYYEGYYAAGPGYG

SEQ ID NO: 255 - protein, 15 aa, Homo sapiens
RSLDNGGYYISPRIT

SEQ ID NO: 256 - protein, 15 aa, Homo sapiens
DDFYTATEGQYQQQP

SEQ ID NO: 257 - protein, 15 aa, Homo sapiens
PDEEDYDYESYEKTT

SEQ ID NO: 258 - protein, 15 aa, Homo sapiens
TSFMMTPYVVTRYYR

SEQ ID NO: 259 - protein, 15 aa, Homo sapiens
SLNSENSYVSPRILT

SEQ ID NO: 260 - protein, 15 aa, Homo sapiens
SRNRDRRYDEVPSDL

SEQ ID NO: 261 - protein, 15 aa, Homo sapiens
GYYDRMDYEDDRLRD

SEQ ID NO: 262 - protein, 15 aa, Homo sapiens
KADGGAEYATYQTKS

SEQ ID NO: 263 - protein, 15 aa, Homo sapiens
FGLARDMYDKEYYSV

SEQ ID NO: 264 - protein, 15 aa, Homo sapiens
PTRPVPSYIQRPDYA

SEQ ID NO: 265 - protein, 15 aa, Homo sapiens
TGKLRPHYPLMPTRP

SEQ ID NO: 266 - protein, 15 aa, Homo sapiens
TAADEEEDEYSGGLC

SEQ ID NO: 267 - protein, 15 aa, Homo sapiens
YTIGTGSYGRCQKIR

SEQ ID NO: 268 - protein, 15 aa, Homo sapiens
FGKFDQIYDVGYQYG

SEQ ID NO: 269 - protein, 15 aa, Homo sapiens
RRLLKPAYGTSGGLP

SEQ ID NO: 270 - protein, 15 aa, Homo sapiens
IVATKPLYVALAQRK

SEQ ID NO: 271 - protein, 15 aa, Homo sapiens
LTVPESTYTSIQGDP

SEQ ID NO: 272 - protein, 15 aa, Homo sapiens
PSSCNDLYATVKDFE

SEQ ID NO: 273 - protein, 15 aa, Homo sapiens
LVPKENDYESISDLQ

SEQ ID NO: 274 - protein, 15 aa, Homo sapiens
IGGSAPIYVKNILPR

SEQ ID NO: 275 - protein, 15 aa, Homo sapiens
NSSGKTEYMAFPKPF

SEQ ID NO: 276 - protein, 15 aa, Homo sapiens
EKLGEGTYATVYKGR

SEQ ID NO: 277 - protein, 15 aa, Homo sapiens
PDGHEYIYVDPMQLP

SEQ ID NO: 278 - protein, 15 aa, Homo sapiens
LYDRPASYKKKSMLD

SEQ ID NO: 279 - protein, 15 aa, Homo sapiens
PNEGDNDYIIPLPDP

SEQ ID NO: 280 - skipped

SEQ ID NO: 281 - protein, 15 aa, Homo sapiens
SATKIALYETPTGWK

SEQ ID NO: 282 - protein, 15 aa, Homo sapiens
LRKTRDQYLMWLTQK

SEQ ID NO: 283 - protein, 15 aa, Homo sapiens
KNETEDQYALMEDED

SEQ ID NO: 284 - protein, 15 aa, Homo sapiens
ALNTTATYAEPYRPI

SEQ ID NO: 285 - protein, 15 aa, Homo sapiens
EKFTIHNYSHSRERP

SEQ ID NO: 286 - protein, 15 aa, Homo sapiens
RARQEELYSELQARE

SEQ ID NO: 287 - protein, 15 aa, Homo sapiens
PPRSEDIYADPAAYV

SEQ ID NO: 288 - protein, 15 aa, Homo sapiens
SLSFPENYQTLPKST

SEQ ID NO: 289 - protein, 15 aa, Homo sapiens
SSEPVGIYQGFEKKT

SEQ ID NO: 290 - protein, 15 aa, Homo sapiens
MQDNSGTYGKIWEGS

SEQ ID NO: 291 - protein, 15 aa, Homo sapiens
TKHIGLVYSGMGPDY

SEQ ID NO: 292 - protein, 15 aa, Homo sapiens
GDFGLSRYMEDSTYY

SEQ ID NO: 293 - protein, 15 aa, Homo sapiens
ELTADFLYEEVHPKQ

SEQ ID NO: 294 - protein, 15 aa, Homo sapiens
REDSARVYENVGLMQ

SEQ ID NO: 295 - protein, 15 aa, Homo sapiens
VPASDDAYPEIEKFF

SEQ ID NO: 296 - protein, 15 aa, Homo sapiens
SRPGGYGYGYGRSRD

SEQ ID NO: 297 - protein, 15 aa, Homo sapiens
YAPPPRDYTYRDYGH

SEQ ID NO: 298 - protein, 15 aa, Homo sapiens
RYPNDSVYANWMLSP

SEQ ID NO: 299 - protein, 15 aa, Homo sapiens
QYDNLEDYHSLPQHQ

SEQ ID NO: 300 - protein, 15 aa, Homo sapiens
SRKAQDCYFMKLHHC

SEQ ID NO: 301 - protein, 15 aa, Homo sapiens
AKLEHLIYLKNRLSS

SEQ ID NO: 302 - protein, 15 aa, Homo sapiens
EPKNYGSYSTQASAA

SEQ ID NO: 303 - protein, 15 aa, Homo sapiens
QPDTEEEYEDSSGNV

SEQ ID NO: 304 - protein, 15 aa, Homo sapiens
GQMPENPYSEVGKIA

SEQ ID NO: 305 - protein, 15 aa, Homo sapiens
KVTIADDYSDPFDAK

SEQ ID NO: 306 - protein, 15 aa, Homo sapiens
EPPDHQYYNDFPGKE

SEQ ID NO: 307 - protein, 15 aa, Homo sapiens
STPGSATYVRYKPSP

SEQ ID NO: 308 - protein, 15 aa, Homo sapiens
KPAQESNYRLLRRNN

SEQ ID NO: 309 - protein, 15 aa, Homo sapiens
IYRKEPLYAAFPGSH

SEQ ID NO: 310 - protein, 15 aa, Homo sapiens
RSGKPRGYAFIEYEH

SEQ ID NO: 311 - protein, 15 aa, Homo sapiens
PQNLNDAYGPPSNFL

SEQ ID NO: 312 - protein, 15 aa, Homo sapiens
RAEPKSIYEYQPGKS

SEQ ID NO: 313 - protein, 15 aa, Homo sapiens
SKSQTDVYNDSTNLA

SEQ ID NO: 314 - protein, 15 aa, Homo sapiens
KHDYNYPYVDSSDFG

SEQ ID NO: 315 - protein, 15 aa, Homo sapiens
TSHVENDYIDNPSLA

SEQ ID NO: 316 - protein, 15 aa, Homo sapiens
KLDSGGFYITSRTQF

SEQ ID NO: 317 - protein, 15 aa, Homo sapiens
EDPMYSMYAKLQNQP

SEQ ID NO: 318 - protein, 15 aa, Homo sapiens
HTETKSLYPSSEIQL

SEQ ID NO: 319 - protein, 15 aa, Homo sapiens
LVNEAPVYSVYSKLH

SEQ ID NO: 320 - protein, 15 aa, Homo sapiens
ADPGAAPYLKTKFIC

SEQ ID NO: 321 - protein, 15 aa, Homo sapiens
GPLDGSPYAQVQRPP

SEQ ID NO: 322 - protein, 15 aa, Homo sapiens
KLKPMLIYHSENPRA

SEQ ID NO: 323 - protein, 15 aa, Homo sapiens
AQKHPDIYAVPIKTH

SEQ ID NO: 324 - protein, 15 aa, Homo sapiens
SPEDEAIYGPNTKMV

SEQ ID NO: 325 - protein, 15 aa, Homo sapiens
RESSYDIYRVPSSQS

SEQ ID NO: 326 - protein, 15 aa, Homo sapiens
MEGPPPTYSEVIGHY

SEQ ID NO: 327 - protein, 15 aa, Homo sapiens
GPVDGSLYAKVRKKS

SEQ ID NO: 328 - protein, 15 aa, Homo sapiens
KVVYENAYGQFIGPH

SEQ ID NO: 329 - protein, 15 aa, Homo sapiens
NKGKEKIYSAERFLI

SEQ ID NO: 330 - protein, 15 aa, Homo sapiens
METRYNLKSPAVKRL

SEQ ID NO: 331 - protein, 15 aa, Homo sapiens
AFSRVQIYHNPTANS

SEQ ID NO: 332 - protein, 15 aa, Homo sapiens
TENDDDVYRSLEELA

SEQ ID NO: 333 - protein, 15 aa, Homo sapiens
ARGGQVFYNSEYGEL

SEQ ID NO: 334 - protein, 15 aa, Homo sapiens
QVFYNSEYGELSEPS

SEQ ID NO: 335 - skipped

SEQ ID NO: 336 - protein, 15 aa, Homo sapiens
GSSWEAPYSRSKLRP

SEQ ID NO: 337 - protein, 15 aa, Homo sapiens
GVVGGEDYEEVDRYS

(19) United States
(12) Patent Application Publication
(10) Pub. No.: US 2010/0234238 A1
(43) Pub. Date: Sep. 16, 2010

(54) METHOD FOR PROFILING KINASE INHIBITORS

(75) Inventors: Matthias Luc Aimé Versele, Beerse (BE); Timothy Pietro Suren Perera, Beerse (BE); Willem Jan-Paul Edmond Talloen, Beerse (BE)

Correspondence Address: PHILIP S. JOHNSON;JOHNSON & JOHNSON, ONE JOHNSON & JOHNSON PLAZA, NEW BRUNSWICK, NJ, 08933-7003, US

(73) Assignee: Janssen Pharmaceutica N V, Beerse (BE)

(21) Appl. No.: 12/446,682

(22) PCT Filed: Oct. 29, 2007
(86) PCT No.: PCT/EP2007/061614

§ 371 Date: Apr. 22, 2009

(30) Foreign Application Priority Data
Oct. 27, 2006 (EP) 06123106.4

(51) Int. Cl. C40B 30/04; C40B 40/10

(52) U.S. Cl. 506/9; 506/18

(57) ABSTRACT

The present invention is concerned with method for pharmacologically profiling compounds using an array of substrates, in particular kinase substrates, immobilized on a porous matrix. This method was found particular useful in the prediction of drug response, i.e. to enable the distinction between responders and non-responders in the treatment of cells, tissues, organs or warm-blooded animals with the compound to be tested, and in compound differentiation.

### FIELD OF THE INVENTION

The present invention is concerned with a method for pharmacologically profiling compounds using an array of substrates, in particular kinase substrates, immobilized on a porous matrix. More particularly, a method useful in the prediction of drug response, i.e. to enable the distinction between responders and non-responders in the treatment of cells, tissues, organs or warm-blooded animals with the compound to be tested, and in compound differentiation, is disclosed.

### BACKGROUND OF THE INVENTION

The cost of drug discovery and development is increasing, while the rate of new drug approvals is declining. In contrast to major technological advances with in silico and in vitro primary screening tools, there are only limited advances in the tools available for establishing the actions of agents in the complex biochemical networks characteristic of fully assembled living systems. Recent advances in genomics and proteomic technologies have begun to address this challenge by providing the tools that allow analyzing variations in gene transcription and protein expression at the protein level, in samples of high biological complexity. For instance, genomic and proteomic signatures have provided insights into the molecular mechanisms of a range of physiological and pathological processes, such as for example the pathology of cancer (Vogelstein, B., Kinzler, K. W., Nat. Med. 10(8), 789-99 (2004)), including tumor invasion (Gupta, G. P., et al. Cold Spring Harb Symp Quant Biol. 70:149-58 (2005)).

However, the general application of these methods to establish the actions of agents in complex biological systems, is hampered by the given that these methods rely on changes in protein abundance to deduce their role in cellular processes and, therefore, provide only an indirect estimate of dynamics in protein function. Indeed, several important forms of post-transcriptional regulation, including protein-protein and protein-small-molecule interactions, determine protein function and may or may not be directly reflected in gene expression signatures. To address this issue, a chemical proteomic strategy referred to as activity-based protein profiling (ABPP) has emerged that utilizes active site-directed probes to profile the functional state of enzyme families directly in complex proteomes (Jessani, N., Cravatt, B. F., Curr Opin Chem. Biol. February; 8(1):54-9 (2004); Evans, M. J., Cravatt, B. F. Chem. Rev. August; 106(8):3279-301 (2006)). By development of chemical probes that capture fractions of the proteome based on shared functional properties, rather than mere abundance, ABPP interrogates portions of the biomolecular space that are inaccessible to other large-scale profiling methods. More than a dozen enzyme classes are now addressable by ABPP, including all major classes of proteases, kinases, phosphatases, glycosidases, and oxidoreductases. The application of ABPP to a number of cell and animal models has succeeded in identifying enzyme activities associated with a range of diseases, including cancer, malaria, and metabolic disorders. The ABPP method also facilitates the generation of selective inhibitors for disease-linked enzymes, including enzymes of uncharacterized function. In summary, ABPP constitutes a powerful hypothesis-generating technology engine, illuminating which members of enzyme superfamilies are associated with specific physiological or pathological processes and, at the same time, facilitating the creation of selective chemical reagents to test the functions of these proteins.

The human genome encompasses some 2,000 proteins that utilize adenosine 5′-triphosphate (ATP) in one way or another and some 500 of these encode for protein kinases, i.e. the protein-tyrosine and protein-serine/threonine kinases, that share a catalytic domain conserved in sequence and structure but which are notably different in how their catalysis is regulated. Substrate phosphorylation by these enzymes is nature's predominant molecular way of organizing cellular signal transduction and regulating biochemical processes in general. It is not surprising, therefore, that abnormal phosphorylation of cellular proteins is a hallmark of disease and that there is a growing interest in the use of kinase inhibitors as drugs for therapeutic intervention in many disease states such as cancer, diabetes, inflammation and arthritis. It is accordingly understandable that a number of ABPP approaches to interrogate the kinase proteome have been developed. In one method the kinase substrates are fluorescently labeled and a phosphorylation-induced fluorescence change allows real-time visualization of protein kinase activity in both cell lysates and living cells (Chen, Calif., et al. Biochim. Biophys. Acta. 1697(1-2):39-51 (2004)). In another method the phosphorylation of the peptide substrates is determined using fluorescently labeled anti-phosphotyrosine antibodies (van Beuningen, R., et al. Clinical Chemistry 47:1931-1933 (2001); Schuller A. et al., 11th Annual World Congres of Drug Discovery Technology (8-10 Aug. 2006), Boston, Mass., USA).

Protein tyrosine kinases (PTKs) are enzymes that catalyze the transfer of phosphate from ATP to tyrosine residues in polypeptides. The human genome contains about 90 functional PTKs that regulate cellular proliferation, survival, differentiation and motility. Many members of the PTK family have been identified as oncogenes over the last 25 years. More recently, inhibition of tyrosine kinase activity has become an important new route to treat cancer. Imatinib (Gleevec) is a very effective drug to treat patients with Philadelphia-chromosome (Ph) positive chronic myeloid leukemia (CML); imatinib inhibits the constitutive tyrosine kinase activity of BCR-ABL, the gene product encoded by the bcr-abl fusion gene, a result of the Ph translocation. Imatinib is also effective as a treatment for gastro-intestinal tumors (GIST). The underlying mechanism is that GISTs are often the result of overactivation of the receptor tyrosine kinases cKIT or PDGFRalpha, both of which are also inhibited by imatinib. However, a significant problem associated with imatinib treatment is the occurrence of resistance upon prolonged treatment, both in CML and in GIST. Two other approved molecules, erlotinib (Tarceva) and gefitinib (Iressa), are tyrosine kinase inhibitors primarily targeted at the EGFR receptor. The clinical efficacy of erlotinib and gefitinib is by far not as impressive as imatinib: the response rate of erlotinib and gefitinib in an unselected non-small-cell lung cancer (NSCLC) patient population is between 10 and 20%. In addition, acquired resistance occurs frequently and rapidly during treatment with EGFR inhibitors. Hence, the early detection of emerging resistance during treatment, and the stratification of drug-naïve patients that are likely to respond to a kinase inhibitor from those that are not, will save patients the trouble and the precious time undergoing useless therapy (and provide the opportunity to timely undergo alternative treatments), will save money for patients and reimbursement agencies, and will increase the chances of approval of a drug in a more limited but well-defined patient population. Additionally, during the clinical development of a drug, these stratification tools can be employed to probe for indications with a particularly high fraction of likely responders.

Several examples of such prediction tools have been developed and some are in clinical use. Trastuzumab (Herceptin), a monoclonal antibody directed against the extracellular domain of Her2, is only administered to metastatic breast cancer patients that overexpress Her2. Activating mutations in EGFR have been correlated with exquisite sensitivity to EGFR inhibitors, both in vitro and in the clinic. Conversely, secondary mutations in EGFR have been associated with acquired resistance to erlotinib and/or gefitinib; likewise, mutations in the kinase domains of BCR-ABL, cKIT and PDGRalpha have been associated with resistance to imatinib. Also mutations in key downstream molecules in the receptor tyrosine kinase signaling cascades that allow for RTK-independent signaling, such as constitutive overactive RAS, and inactivated or deleted PTEN (the PI3 phosphatase), sometimes inversely correlate with response to RTK inhibitors. With the advent of genome-wide profiling technology, and instigated by the realization that many kinase inhibitors have multiple targets and that the relevant targets critical for effectiveness of a treatment are not always clear, unbiased methods to stratify responders and non-responders have been suggested. The most advertised of these methods is the use of gene expression signatures. In such cases, a whole-genome expression profile (before treatment) of several responders is compared to that of several non-responders, and genes that are differentially expressed between the two groups can be used to predict the likelihood of unknown cases. A critical disadvantage of this method is that it is not directly related to the mechanism of action of kinase inhibitors and hence relies on indirect parameters to assess responsiveness of a sample. Moreover, this method (and most other response-prediction methods) are based on parameters (in this case gene expression) in the untreated sample only. As a consequence, these methods are very sensitive to tumor heterogeneity and sample quality.

It has now been found that the ABPP approach is particular useful in pharmacologically profiling a compound with the objective to determine patient response to a given drug or regimen. In particular in oncology, the use of ABPP has proven useful to provide “fingerprints” that can predict response to therapeutics in cell lysates prepared from cancer cell lines, xenograft tumors or cancer patient biopsies.

### AIMS OF THE INVENTION

The aim of the present invention is to provide a method for providing a pharmacological profile of kinase inhibitors.

A further aim is to provide a use for said method for reliably predicting a patient's response to a specific kinase inhibitor.

Another aim of the present invention is to provide a tool for providing a pharmacological profile of kinase inhibitors

### SUMMARY OF THE INVENTION

The present invention concerns a method for obtaining a pharmacological profile of a kinase inhibitor using a first and a second array of substrates immobilized on a porous matrix, said method comprising the subsequent steps of;
(i) preparing a cell lysate from a cell line, including cancer cell lines; primary and immortalized tissue cell lines; non-human animal model biopsies and patient biopsies;
(ii) filtering said cell lysate over a filter in the 10 to 0.1 micrometer range to obtain a filtered cell lysate;
(iii) contacting said first array of substrates in the presence of the kinase inhibitor with a first fraction of said filtered cell lysate and determining the response of said first array
(iv) contacting said second array of substrates in the absence of the kinase inhibitor with a second fraction of said filtered cell lysate and determining the response of said second array; and
   obtaining the pharmacological profile as the ratio of the array substrate response in step (iii) over the array substrate response in step (iv).

Preferably, said substrates are selected from the group consisting of hormone receptors, peptides, enzymes, oligonucleotides, monoclonal antibodies, haptens and aptamers. More preferably, said substrates are kinase substrates.

Advantageously, said substrates are peptide kinase substrates.

In a preferred embodiment, said substrates are at least two peptide kinase substrates selected from the group consisting of the peptide kinase substrates with sequence numbers 1 to 337. Advantageously, said substrates consist either of the peptide kinase substrates with sequence numbers 15, 16, 22, 34, 62, 83, 86, 87, 100, 105, 108, 110, 113, 125, 129, and 133; of the peptide kinase substrates with sequence numbers 15, 16, 21, 23, 38, 42, 53, 62, 69, 77, 83, 86, 91, 94, 103, 112, 114, 129, 133, 136 and 138; of the peptide kinase substrates with sequence numbers 142, 2, 163, 173, 177, 190, 161, 197, 207, 208, 213, 241, 73, 252, 255, 258, 262, 79, 87, 266, 86, 269, 95, 296, 303, 305, 308, and 138; or of the peptide kinase substrates with sequence numbers 5, 10, 38, 30, 54, 57, 68, 72, 73, 74, 82, 91, 98, 99, 102, 104, 110, 135, 118, 119, 71, 138.

In the method of the present invention, the cell lysate is preferably prepared from a cancer cell line; xenograft tumor or cancer patient biopsy, including tumor and normal tissue.

It is preferred that the response of the array of substrates is determined using a detectable signal, said signal resulting from the interaction of the sample with the array of substrates, advantageously using detectably labeled antibodies, more advantageously using fluorescently labeled anti-phosphotyrosine antibodies.

Another aspect of the present invention includes the use of the pharmacological profile determined according to the method of the present invention, to enable the distinction between responders and non-responders in the treatment of cells, tissues, organs or warm-blooded animals for a kinase inhibitor.

Preferably, the kinase inhibitor to be tested is selected from the group consisting of MTKI1, 605 and erlotinib.

Use according to any one of claim 14 or 15 wherein pharmacological profile is determined using an array of substrates comprising at least 2 peptides selected from the peptide kinase substrates with sequence numbers 15, 16, 22, 34, 62, 83, 86, 87, 100, 105, 108, 110, 113, 125, 129, and 133.

Use according to any one of claim 14 or 15 wherein pharmacological profile is determined using an array of substrates comprising at least 2 peptides selected either from the peptide kinase substrates with sequence numbers 15, 16, 22, 34, 62, 83, 86, 87, 100, 105, 108, 110, 113, 125, 129, and 133; from the peptide kinase substrates with sequence numbers 15, 16, 21, 23, 38, 42, 53, 62, 69, 77, 83, 86, 91, 94, 103, 112, 114, 129, 133, 136 and 138; from the peptide kinase substrates with sequence numbers 142, 2, 163, 173, 177, 190, 161, 197, 207, 208, 213, 241, 73, 252, 255, 258, 262, 79, 87, 266, 86, 269, 95, 296, 303, 305, 308, and 138; or from the peptide kinase substrates with sequence numbers 5, 10, 38, 30, 54, 57, 68, 72, 73, 74, 82, 91, 98, 99, 102, 104, 110, 135, 118, 119, 71, 138.

The present invention also concerns a method to enable the distinction of responders from non-responders cell lines and tumors to the treatment with 4,6-ethanediylidenepyrimido[4,5-b][6,1,12]benzoxadiazacyclopentadecine, 17-bromo-8,9,10,11,12,13,14,19-octahydro-20-methoxy-13-methyl-(MTKI 1); or the pharmaceutically acceptable acid or base addition salts thereof; or erlotinib, or compound 605, said method comprising;

providing a sample from said cell lines and/or tumors;

contacting an array of substrates with said sample in the presence of MTKI1, erlotinib or 605;

contacting an array of substrates with said sample in the absence of MTKI1, erlotinib or 605;

determine the response of said array to the sample in step (ii); determine the response of said array to the sample in step (iii); and

obtain the pharmacological profile as the ratio in response of the array in steps (iv) over step (v); characterized in that the array of substrates comprises at least 2 peptides selected from the group consisting of the peptide kinase substrates with sequence numbers 15, 16, 22, 34, 62, 83, 86, 87, 100, 105, 108, 110, 113, 125, 129, and 133; and wherein a responder is identified as an inhibition (ratio<1.0) in response for at least two of the peptides selected from the peptide kinase substrates with sequence numbers 15, 16, 22, 34, 62, 83, 86, 87, 100, 105, 108, 110, 113, 125, 129, and 133.

A responder is preferably identified as an inhibition in response (ratio at least <0.80) for at least two of the peptides selected from the group consisting of the peptide kinase substrates with sequence numbers 15, 16, 22, 34, 62, 83, 86, 87, 100, 105, 108, 110, 113, 125, 129, and 133.

Preferably, the array of substrates comprising at least 3 peptides selected from the group consisting of the peptide kinase substrates with sequence numbers 15, 16, 22, 34, 62, 83, 86, 87, 100, 105, 108, 110, 113, 125, 129, and 133; in particular the array of substrates comprises the peptide kinase substrates with sequence numbers 15, 16, 22, 34, 62, 83, 86, 87, 100, 105, 108, 110, 113, 125, 129, and 133; more in particular the array of substrates consists of the peptide kinase substrates with sequence numbers 15, 16, 22, 34, 62, 83, 86, 87, 100, 105, 108, 110, 113, 125, 129, and 133.

In the method above, the group consisting of the peptide kinase substrates with sequence numbers 15, 16, 22, 34, 62, 83, 86, 87, 100, 105, 108, 110, 113, 125, 129, and 133, can be replaced with the group consisting of the peptide kinase substrates with sequence numbers 15, 16, 21, 23, 38, 42, 53, 62, 69, 77, 83, 86, 91, 94, 103, 112, 114, 129, 133, 136 and 138; the group consisting of the peptide kinase substrates with sequence numbers 142, 2, 163, 173, 177, 190, 161, 197, 207, 208, 213, 241, 73, 252, 255, 258, 262, 79, 87, 266, 86, 269, 95, 296, 303, 305, 308, and 138; or the group consisting of the peptide kinase substrates with sequence numbers 5, 10, 38, 30, 54, 57, 68, 72, 73, 74, 82, 91, 98, 99, 102, 104, 110, 135, 118, 119, 71, 138.

In any method according to the present invention, the response of the array of substrates is preferably determined using antibodies in a solution free of antifungals, in particular using an azide free solution.

In the methods of the present invention, an overall accuracy of 60%, 70%, preferably 80% or advantageously 90% or higher can be obtained.

Another embodiment of the present invention concerns an array of substrates comprising peptides selected from the group consisting of the peptide kinase substrates with sequence numbers 1 to 337, with the proviso that said array does not consist of peptide kinase substrates with sequence numbers 1-140.

Said array of substrates can consist of the peptide kinase substrates with sequence numbers 1 to 337, or the peptide kinase substrates with sequence numbers 15, 16, 22, 34, 62, 83, 86, 87, 100, 105, 108, 110, 113, 125, 129, and 133, or the peptide kinase substrates with sequence numbers 15, 16, 21, 23, 38, 42, 53, 62, 69, 77, 83, 86, 91, 94, 103, 112, 114, 129, 133, 136 and 138, or the peptide kinase substrates with sequence numbers 142, 2, 163, 173, 177, 190, 161, 197, 207, 208, 213, 241, 73, 252, 255, 258, 262, 79, 87, 266, 86, 269, 95, 296, 303, 305, 308, and 138, or the peptide kinase substrates with sequence numbers 5, 10, 38, 30, 54, 57, 68, 72, 73, 74, 82, 91, 98, 99, 102, 104, 110, 135, 118, 119, 71, 138.

Another aspect of the present invention concerns a method for predicting possible kinase inhibitor response in a patient in the treatment of cancer, comprising the steps of:
(i) Preparing a cell lysate from a cancer patient biopsy, including normal and tumor tissue,
(ii) Contacting a first array of substrates according to the present invention with a fraction of the cell lysate of step (i) in the presence of a kinase inhibitor;
(iii) Contacting a second array of substrates identical to said first array of substrates with a fraction of the cell lysate of step (i) in the absence of the kinase inhibitor; and
   Obtaining a pharmacological profile for said patient as the ratio of the first array of substrates response over the second array of substrates response, wherein said pharmacological profile predicts said possible kinase inhibitor response.

The invention will be further clarified in the following drawings and examples, which are to be considered non-limiting to the scope of protection conferred by the claims.

### BRIEF DESCRIPTION OF THE DRAWINGS

FIG. 1: Ratio of initial velocities of the phosphorylation of detectable peptides in treated over untreated lysates from cell line NCI-H3255. From left to right: DMSO, lapatinib/Tykerb, MTKI1/MTKI, gefitinib/Iressa, erlotinib/Tarceva, ZD6474/zactima. Scale: white=1 (no inhibition); black=0.1 (10-fold inhibition).

FIG. 2: Ratio of initial velocities of the phosphorylation in treated over untreated DU145 samples: left three profiles are derived from cellular treatment with DMSO (outer left lane), MTKI1 (2^{nd} lane) or a histone deacetylase inhibitor (3^{rd} lane); right-most three lanes are derived from lysate treatment of untreated DU145 cells with DMSO (1^{st}. lane), MTKI1 (2^{nd} lane), and the histone deacetylase inhibitor (3^{rd} lane). Scale: white=1 (no inhibition); black=0.1 (10-fold inhibition).

FIG. 3: Ratio of initial velocity of peptide phosphorylation in the presence of solvent (DMSO) over the initial velocity of peptide phosphorylation in the presence of MTKI or Tarceva; Scale: white=1 (no inhibition); black=0.25 (4-fold inhibition)

### DETAILED DESCRIPTION OF THE INVENTION

The present invention describes a method to measure the inhibition of tyrosine kinase activity by small molecule compounds in lysates, prepared from cell lines or tumor samples. Importantly, this method directly measures the relevant mechanism of action of a kinase inhibitor and the parameter that correlates with response status is a relative measure (i.e. the ratio of kinase activity in the absence and in the presence of compound). It is demonstrated for a multi-targeted kinase inhibitor, MTKI-1, that responder cell lines can be discriminated from non-responder cell lines based on these phosphopeptide profiles with an overall accuracy of 82% in 27 cell lines. The kinases that phosphorylate these peptides are closely linked to the mechanism of action of the inhibitor. In addition, it is shown that also in xenograft tumor lysates or for similar kinase inhibitors, many of the same peptides can discriminate responders from non-responders, indicating that this technology should be applicable to patient stratification.

In one embodiment the present invention provides a method for pharmacologically profiling of compounds using an array of substrates immobilized on a porous matrix, said method comprising;
(i) contacting the array of substrates with either an untreated sample or a sample pretreated with the compound to be tested;
(ii) determine the response of said array to the untreated sample;
(iii) determine the response of said array to the pretreated sample; and
(iv) obtain the pharmacological profile as the difference in response of the array in steps (ii) and step (iii).

The substrates as used herein, are meant to include hormone receptors, peptides, enzymes, oligonucleotides, monoclonal antibodies, haptens and aptamers. In particular the substrates used or kinase substrates, more in particular peptide kinase substrates, even more particular the peptide kinase substrates in Table 1, most particular using at least 2, 6, 12, 40, 50, 60, 70, 80, 90, 100, 110, 120 or 130 peptides of the peptide kinase substrates of Table 1. In an even further embodiment the array of substrates comprising at least 2 peptides selected from the group consisting of the peptides with sequence numbers 4, 19, 24, 69, 113, 114, 136 and 138; more in particular the array of substrates consist of the peptides with sequence numbers 4, 19, 24, 69, 113, 114, 136 and 138. In an alternative further embodiment, the array of substrates comprising at least 2 peptides selected from the group consisting of the peptides with sequence numbers 15, 16, 22, 34, 62, 83, 86, 87, 100, 105, 108, 110, 113, 125, 129 and 133, more in particular the array of substrates consist of the peptides with sequence numbers 15, 16, 22, 34, 62, 83, 86, 87, 100, 105, 108, 110, 113, 125, 129 and 133.

In another alternative further embodiment, the array of substrates comprising at least 2 peptides selected from the group consisting of the peptides with sequence numbers 5, 10, 38, 30, 54, 57, 68, 72, 73, 74, 82, 91, 98, 99, 102, 104, 110, 135, 118, 119, 71, 138, more in particular the array of substrates consist of the peptides with sequence numbers 5, 10, 38, 30, 54, 57, 68, 72, 73, 74, 82, 91, 98, 99, 102, 104, 110, 135, 118, 119, 71, 138.

TABLE 1
list of 140 peptides used in
the PAMCHIP96 profiling analysis,
their sequence and Seq.Id.No.

| Seq. | Name | Sequence |
|---|---|---|
| 1 | 41_653_665_Y627 | RLDGENIYIRHSN |
| 2 | ACHB_383_395_Y390 | WGRGTDEYFIRKP |
| 3 | ACHD_383_395_Y390 | YISKAEEYFLLKS |
| 4 | AMPE_5_17_Y12 | EREGSKRYCIQTK |
| 5 | ANXA1_13_25_Y20/T23 | IENEEQEYVQTVK |
| 6 | ANXA2_16_28_Y23/S25 | HSTPPSAYGSVKA |
| 7 | B3AT_39_51_Y46/S50 | TEATATDYHTTSH |
| 8 | C1R_199_211_S206 | TEASGYISSLEYP |
| 9 | CALM_93_105_Y99/S101 | FDKDGNGYISAAE |
| 10 | CALM_95_107_Y99/S101 | KDGNGYISAAELR |
| 11 | CBL_693_705_Y700 | EGEEDTEYMTPSS |
| 12 | CD3Z_146_158_Y153 | STATKDTYDALHM |
| 13 | CD79A_181_193_Y182/Y188 | EYEDENLYEGLNL |
| 14 | CDK2_8_20_T14/Y15 | EKIGEGTYGVVYK |
| 15 | CDK7_157_169_S164 | GLAKSFGSPNRAY |
| 16 | CREB1_122_134_Y134/5133 | QKRREILSRRPSY |
| 17 | CRK_214_226_Y221 | GPPEPGPYAQPSV |
| 18 | CTNB1_79_91_Y86 | VADIDGQYAMTRA |
| 19 | DCX_109_121_Y112/5116 | GIVYAVSSDRFRS |
| 20 | DDR1_506_518_Y513 | LLLSNPAYRLLLA |
| 21 | DDR1_785_797_Y792/Y796/Y797 | FGMSRNLYAGDYY |
| 22 | DDR2_733_745_Y740 | RNLYSGDYYRIQG |
| 23 | DYR1A_212_224_Y219 | KHDTEMKYYIVHL |
| 24 | DYR1A_312_324_Y319/Y321 | CQLGQRIYQYIQS |
| 25 | EFS_246_258_Y253 | GGTDEGIYDVPLL |
| 26 | EFS_246_258_Y253F | GGTDEGIFDVPLL |
| 27 | EGFR_1062_1074_Y1069 | EDSFLQRYSSDPT |
| 28 | EGFR_1103_1115_Y1110 | GSVQNPVYHNQPL |
| 29 | EGFR_1118_1130_Y1125 | APSRDPHYQDPHS |
| 30 | EGFR_1165_1177_Y1172 | ISLDNPDYQQDFF |
| 31 | EGFR_1190_1202_Y1197 | STAENAEYLRVAP |
| 32 | EGFR_862_874_Y869 | LGAEEKEYHAEGG |
| 33 | EGFR_908_920_Y915 | MTFGSKPYDGIPA |
| 34 | ENOG_37_49_Y43 | SGASTGIYEALEL |
| 35 | EPHA_1_774_786_Y781 | LDDFDGTYETQGG |
| 36 | EPHA2_581_593_Y588 | QLKPLKTYVDPHT |
| 37 | EPHA2_765_777_Y772 | EDDPEATYTTSGG |
| 38 | EPHA4_589_601_Y596 | LNQGVRTYVDPFT |
| 39 | EPHA4_921_933_Y928 | QAIKMDRYKDNFT |
| 40 | EPHA7_607_619_Y608/Y614 | TYIDPETYEDPNR |
| 41 | EPHB1_771_783_Y778 | DDTSDPTYTSSLG |
| 42 | EPHB1_921_933_Y928 | SAIKMVQYRDSFL |
| 43 | EPHB4_583_595_Y590 | IGHGTKVYIDPFT |
| 44 | EPOR_361_373_Y368 | SEHAQDTYLVLDK |
| 45 | EPOR_419_431_Y426 | ASAASFEYTILDP |
| 46 | ERBB2_1241_1253_Y1248 | PTAENPEYLGLDV |
| 47 | ERBB2_870_882_Y877 | LDIDETEYHADGG |
| 48 | ERBB2_945_957_Y952 | PISTIDVYMIMVK |
| 49 | ERBB4_1181_1193_Y1188 | QALDNPEYHNASN |
| 50 | ERBB4_1277_1289_Y1284 | IVAENPEYLSEFS |
| 51 | F261_26_38_S33 | RLQRRRGSSIPQF |
| 52 | FABH_13_25_Y19 | DSKNFDDYMKSLG |
| 53 | FAK1_569_581_Y576/Y577 | RYMEDSTYYKASK |
| 54 | FAK2_572_584_Y579/Y580 | RYIEDEDYYKASV |
| 55 | FER_707_719_Y714 | RQEDGGVYSSSGL |
| 56 | FES_706_718_Y713 | REEADGVYAASGG |
| 57 | FGFR1_759_771_Y766 | ALTSNQEYLDLSM |
| 58 | FGFR2_762_774_Y769 | TLTTNEEYLDLSQ |
| 59 | FGFR3_641_653_Y648 | DVHNLDYYKKTTN |
| 60 | FGFR3_753_765_Y760 | TVTSTDEYLDLSA |
| 61 | FRK_380_392_Y387 | KVDNEDIYESRHE |
| 62 | GSK3B_209_221_Y216 | RGEPNVSYICSRY |
| 63 | H2BR_26_38_S32/S36 | DGKKRKRSRKESY |
| 64 | INSR_1348_1360_S1354/Y1355 | SLGFKRSYEEHIP |
| 65 | NSR_993_1005_Y993/Y999 | YASSNPEYLSASD |
| 66 | IRS1_1222_1234_Y1230 | SSEDLSAYASISF |
| 67 | IRS2_535_545_Y540 | GGGGGEFYGYMTM |
| 68 | JAK1_1015_1027_Y1022/Y1023 | AIETDKEYYTVKD |
| 69 | K2C6E_53_65_S59 | GAGFGSRSLYGLG |
| 70 | K2C8_425_437_S431 | SAYGGLTSPGLSY |
| 71 | KSYK_518_530_Y525/Y526 | ALRADENYYKAQT |
| 72 | LAT_194_206_Y200 | MESIDDYVNVPES |
| 73 | LAT_249_261_Y255 | EEGAPDYENLQEL |
| 74 | LCK_387_399_Y394 | RLIEDNEYTAREG |
| 75 | LTK_669_681_Y772/Y776/Y777 | RDIYRASYYRRGD |
| 76 | MBP_198_210_Y203 | ARTAHYGSLPQKS |
| 77 | MBP_259_271_Y261/Y268/S266 | FGYGGRASDYKSA |
| 78 | MBP_263_275_Y268/5266/5270 | GRASDYKSAHKGF |
| 79 | MET_1227_1239_Y1230/Y1234/ | RDMYDKEYYSVHN |
| | Y1235 | |
| 80 | MK01_180_192_Y187 | HTGFLTEYVATRW |
| 81 | MK01_198_210_Y205 | IMLNSKGYTKSID |
| 82 | MK07_211_223_T218/Y220 | AEHQYFMTEYVAT |
| 83 | MK10_216_228_T221/Y223 | TSFMMTPYVVTRY |
| 84 | MK12_178_190_T183/Y185 | ADSEMTGYVVTRW |
| 85 | MK14_173_185_T180/Y182 | RHTDDEMTGYVAT |
| 86 | NCF1_313_325_S315/S320 | QRSRKRLSQDAYR |
| 87 | NPT2_501_513_T508 | AKALGKRTAKYRW |
| 88 | NTRK1_48_501_Y496 | HIIENPQYFSDAC |
| 89 | NTRK2_50_521_Y516 | PVIENPQYFGITN |
| 90 | NTRK2_695_707_Y702/Y706/Y707 | FGMSRDVYSTDYY |
| 91 | NTRK2_699_711_Y702/Y706/Y707 | RDVYSTDYYRVGG |
| 92 | ODBA_340_352_S345 | DDSSAYRSVDEVN |
| 93 | ODPAT_291_303_S291/S293 | SMSDPGVSYRTRE |
| 94 | P2AB_297_309_T304/Y307 | EPHVTRRTPDYFL |
| 95 | P85A_600_612_Y607/S608 | NENTEDQYSLVED |
| 96 | PAXI_111_123_Y118 | VGEEEHVYSFPNK |
| 97 | PAXI_24_36_Y31 | FLSEETPYSYPTG |
| 98 | PDPK1_2_14_Y9 | ARTTSQLYDAVPI |
| 99 | PDPK1_369_381_Y373/Y376 | DEDCYGNYDNLLS |
| 100 | PECA1_706_718_Y713 | KKDTETVYSEVRK |
| 101 | PERI_459_471_Y471 | QRSELDKSSAHSY |
| 102 | PGFRB_1002_1014_Y1009 | LDTSSVLYTAVQP |
| 103 | PGFRB_572_584_Y579/Y581 | VSSDGHEYIYVDP |
| 104 | PGFRB_709_721_Y716 | RPPSAELYSNALP |
| 105 | PGFRB_768_780_Y771/Y775/Y778 | SSNYMAPYDNYVP |
| 106 | PGFRB_771_783_Y771/Y775/Y778 | YMAPYDNYVPSAP |
| 107 | PLCG1_1246_1258_S1248/Y1253 | EGSFESRYQQPFE |
| 108 | PLCG1_764_776_Y771 | IGTAEPDYGALYE |
| 109 | PLCG1_776_788_Y783 | EGRNPGFYVEANP |
| 110 | PRRX2_202_214_Y214 | WTASSPYSTVPPY |
| 111 | PTN11_535_547_Y542 | SKRKGHEYTNIKY |
| 112 | RAF_1_331_343_S337/S338/Y339/ | RPRGQRDSSYYWE |
| | Y340 | |
| 113 | RASA1_453_465_Y460 | TVDGKEIYNTIRR |
| 114 | RB_804_816_S807/S811 | IYISPLKSPYKIS |
| 115 | RBL2_99_111_Y111/S103 | VPTVSKGTVEGNY |
| 116 | RET_1022_1034_Y1029 | TPSDSLIYDDGLS |
| 117 | RET_680_692_Y687 | AQAFPVSYSSSGA |
| 118 | RON_1346_1358_Y1353 | SALLGDHYVQLPA |
| 119 | RON_1353_1365_Y1356/Y1360 | YVQLPATYMNLGP |
| 120 | SRC8_CHICK_470_482_Y477 | VSQREAEYEPETV |
| 121 | SRC8_CHICK_476_488_Y477/Y483 | EYEPETVYEVAGA |
| 122 | SRC8_CHICK_492_504_Y499 | YQAEENTYDEYEN |
| 123 | STA5A_687_699_Y694 | LAKAVDGYVKPQI |
| 124 | STAT1_694_706_Y701 | DGPKGTGYIKTEL |
| 125 | STAT2_683_695_Y690 | NLQERRKYLKHRL |
| 126 | STAT3_698_710_Y705 | DPGSAAPYLKTKF |
| 127 | STAT4_686_698_Y693 | TERGDKGYVPSVF |
| 128 | STAT4_714_726_Y725 | PSDLLPMSPSVYA |
| 129 | SYN1_2_14_S9 | NYLRRRLSDSNFM |
| 130 | TAU_512_524_Y514/T522 | SGYSSPGSPGTPG |
| 131 | TEC_512_524_Y519 | RYFLDDQYTSSSG |
| 132 | TNNT1_2_14_Y9 | SDTEEQEYEEEQP |
| 133 | TYRO3_679_691_Y686 | KIYSGDYYRQGCA |
| 134 | VEGFR1_1049_1061_Y1053 | KNPDYVRKGDTRL |
| 135 | VEGFR2_1052_1064_Y1059 | DIYKDPDYVRKGD |
| 136 | VEGFR2_944_956_Y951 | RFRQGKDYVGAIP |
| 137 | VGFR3_1061_1073_Y1063/Y1068/ | DIYKDPDYVRKGS |
| | S1073 | |
| 138 | VINC_815_827_Y821 | KSFLDSGYRILGA |
| 139 | ZAP70_485_497_Y492/Y493 | ALGADDSYYTARS |
| 140 | ZBT16_621_633_S628 | LRTHNGASPYQCT |

In an alternative embodiment, the substrates used are kinase substrates, more in particular peptide kinase substrates, even more particular the peptide kinase substrates in Table 2, most particular using at least 2, 6, 12, 16, 20, 24, 28, 32, 36, 40, 50, 60, 70, 80, 90, 100, 110, 120, 130, 150, 180, 200, 220 or 240 peptides of the peptide kinase substrates of Table 2. In an even further embodiment the array of substrates comprising at least 2 peptides selected from the group consisting of peptides with sequence numbers 142, 2, 163, 173, 177, 190, 161, 197, 207, 208, 213, 241, 73, 252, 255, 258, 262, 79, 87, 266, 86, 269, 95, 296, 303, 305, 308, and 138; more in particular the array of substrates consist of the peptides with sequence numbers 142, 2, 163, 173, 177, 190, 161, 197, 207, 208, 213, 241, 73, 252, 255, 258, 262, 79, 87, 266, 86, 269, 95, 296, 303, 305, 308, and 138.

TABLE 2
list of 256 peptides used in an
alternative profiling analysis,
their sequence en Seq.Id.No.

| Seq. | Name | Sequence |
|---|---|---|
| 1 | 41_653_665_Y627 | RLDGENIYIRHSN |
| 141 | ABL_Y272 | HKLGGGQYGEVYEGV |
| 142 | ABLIM1_350_364_Y357 | RTSSESIYSRPGSSI |
| 143 | ABLIM1_454_468_Y461 | GSINSPVYSRHSYTP |
| 2 | ACHB_383_395_Y390 | WGRGTDEYFIRKP |
| 3 | ACHD_383_395_Y390 | YISKAEEYFLLKS |
| 144 | ACLY_675_689_Y682 | SRTTDGVYEGVAIGG |
| 145 | ACTB_159_173_Y166 | VTHTVPIYEGYALPH |
| 146 | ADAM9_805_819_Y815 | PARPAPAPPLYSSLT |
| 147 | ADD2_482_496_Y489 | PNQFVPLYTDPQEVL |
| 148 | AGBL2_10_24_Y17 | KQTIPDPYEDFMYRH |
| 149 | ANKRD26_289_303_Y296 | RKNLEATYGTVRTGN |
| 150 | ANXA2_192_206_Y199 | DQDARDLYDAGVKRK |
| 151 | ANXA2_231_245_Y238 | RYKSYSPYDMLESIR |
| 152 | APCDD1_103_117_Y110 | FKAYQFYYGSNRCTN |
| 153 | APP_750_764_Y757 | SKMQQNGYENPTYKF |
| 154 | ARHGEF_10L_124_138_Y131 | ALEEDVIYDDVPCES |
| 155 | BAG3_240_254_Y247 | YQTHQPVYHKIQGDD |
| 156 | BCAR1_242_256_Y249 | APGPQDIYDVPPVRG |
| 157 | BCAR1_320_334_Y327 | PLLREETYDVPPAFA |
| 158 | BCAR1_355_369_Y362 | SPPAEDVYDVPPPAP |
| 159 | BCAR1_365_379_Y372 | PPPAPDLYDVPPGLR |
| 160 | BCAR1_657_671_Y664 | EGGWMEDYDYVHLQG |
| 161 | BCAR1_380_394_Y387 | RPGPGTLYDVPRERV |
| 162 | BCR_239_253_Y246 | SCGVDGDYEDAELNP |
| 163 | C11orf35_217_231_Y224 | WNSVARRYPNLFTNM |
| 164 | C19orf21_88_102_Y95 | EDEGWQVYRLGARDA |
| 165 | C1orf73_928_942_Y935 | VKSLEDPYSQQIRLQ |
| 166 | C20orf1_8_281_295_Y288 | CPFIDNTYSCSGKLL |
| 167 | C2orf4_203_217_Y210 | DESQGEIYRSIEHLD |
| 168 | C3orf6_138_152_Y145 | RAYADSYYYEDGGMK |
| 169 | C3orf6_272_286_Y279 | TDGEDADYTHFTNQQ |
| 170 | C9orf86_672_686_Y683 | APGGRHPGGGDYEEL |
| 171 | CALR3_68_82_Y75 | TTQNGRFYAISARFK |
| 172 | CAV1_7_21_Y14 | VDSEGHLYTVPIREQ |
| 173 | CBL_667_681_Y674 | SSSANAIYSLAARPL |
| 11 | CBL_693_705_Y700 | EGEEDTEYMTPSS |
| 174 | CBLB_882_896_Y889 | TNRTSQDYDQLPSCS |
| 13 | CD79A_181_193_Y182/Y188 | EYEDENLYEGLNL |
| 14 | CDK2_8_20_T14/Y15 | EKIGEGTYGVVYK |
| 175 | CDK3_12_2_Y19 | EGTYGVVYKAKNRET |
| 15 | CDK7_157_169_S164 | GLAKSFGSPNRAY |
| 176 | CENTB2_735_749_Y742 | MRESEGLYGQPGDET |
| 177 | CFL1_61_75_Y68 | GQTVDDPYATFVKML |
| 178 | CLDN1_197_211_Y210 | RPYPKPAPSSGKDYV |
| 179 | CLDN2_187_201_Y194 | SQRNRSNYYDAYQAQ |
| 16 | CREB1_122_134_Y134/5133 | QKRREILSRRP SY |
| 180 | CTNND1_214_228_Y221 | SRHYEDGYPGGSDNY |
| 181 | CTTN_414_428_Y421 | RLPSSPVYEDAASFK |
| 182 | CDC2_12_26_Y19 | EGTYGVVYKGRHKTT |
| 183 | DCBLD2_558_572_Y565 | KKKTEGTYDLPYWDR |
| 184 | DCBLD2_743_757_Y750 | PAPDELVYQVPQSTQ |
| 19 | DCX_109_121_Y112/S116 | GIVYAVSSDRFRS |
| 20 | DDR1_506_518_Y513 | LLLSNPAYRLLLA |
| 22 | DDR2_733_745_Y740 | RNLYSGDYYRIQG |
| 185 | DDX3X_259_273_Y266 | RYGRRKQYPISLVLA |
| 186 | DDX5_195_209_Y202 | RLKSTCIYGGAPKGP |
| 187 | DKFZp434C0328_451_465_Y458 | RVSTDLKYRKQPWGL |
| 188 | DKFZp761P0423_404_418_Y411 | ATQPEPIYAESTKRK |
| 189 | DOK1_308_322 Y315 | CP SQDSLYSDPLDST |
| 190 | DOK1_402_416 Y409 | YNPATDDYAVPPPRS |
| 24 | DYR1A_312_324 Y319/Y321 | CQLGQRIYQYIQS |
| 191 | EFNB1_310_324 Y317 | ENNYCPHYEKVSGDY |
| 30 | EGFR_1165_1177_Y1172 | ISLDNPDYQQDFF |
| 192 | EIF3S9_442_456 Y449 | TLDTLSIYETPSMGL |
| 193 | ELMO2_41_55_Y48 | WSLPNPEYYTLRYAD |
| 194 | ELMO2_706_720_Y717 | IPKEPSSYDFVYHYG |
| 195 | | |
| 35 | EPHA1_774_786_Y781 | LDDFDGTYETQGG |
| 37 | EPHA2_765_777_Y772 | EDDPEATYTTSGG |
| 38 | EPHA4_589_601_Y596 | LNQGVRTYVDPFT |
| 42 | EPHB1_921_933_Y928 | SAIKMVQYRDSFL |
| 196 | EPHB2_774_788_Y781 | DDTSDPTYTSALGGK |
| 197 | EPHB3_607_621_Y614 | VYIDPFTYEDPNEAV |
| 198 | EPHB4_767_781_Y774 | ENSSDPTYTSSLGGK |
| 44 | EPOR_361_373_Y368 | SEHAQDTYLVLDK |
| 199 | ERBB2_1241_1255_Y1248 | PTAENPEYLGLDVPV |
| 47 | ERBB2_870_882_Y877 | LDIDETEYHADGG |
| 200 | ERBB3_1152_1166_Y1159 | EEEDVNGYVMPDTHL |
| 201 | ERRFI_1_388_402_Y395 | KVSSTHYYLLPERPP |
| 202 | FUR_273 287_Y280 | TSSKKVIYSQPSARS |
| 203 | FAK_Y407 | IIDEEDTYTMPSTRD |
| 204 | FAK_Y861 | PIGNQHIYQPVGKPD |
| 205 | FAK_Y925 | DRSNDKVYENVTGLV |
| 53 | FAK1_569_581_Y576/Y577 | RYMEDSTYYKASK |
| 55 | FER_707_719_Y714 | RQEDGGVYSSSGL |
| 206 | FGD6_747_761_Y754 | EYENIRHYEEIPEYE |
| 207 | FGFR10P_330_344_Y337 | GTGEDDDYVDDFNST |
| 208 | FKS | EFGTYGTLSK |
| 209 | FLJ11273_43_57_Y50 | GDVSQFPYVEFTGRD |
| 210 | FLJ12747_469_483_Y476 | RHGEQSLYSPQTPAY |
| 211 | FLJ20625_33_47_Y40 | LNGAEPNYHSLPSAR |
| 212 | FLT1_Y1333 | PPDYNSVVLYSTPPI |
| 213 | FYN_206_220_Y213 | RKLDNGGYYITTRAQ |
| 214 | GAB1_252_266_Y259 | ASVDSSLYNLPRSYS |
| 215 | GOLGA5_47_61_Y54 | QQNTDLIYQTGPKST |
| 216 | GPRC5C_392_406_Y399 | KVPSEGAYDIILPRA |
| 217 | GRLF1_1081_1095_Y1088 | DGFDPSDYAEPMDAV |
| 62 | GSK3B_209_221_Y216 | RGEPNVSYICSRY |
| 63 | H2BR_26_38_S32/S36 | DGKKRKRSRKESY |
| 218 | H41_183_197_Y190 | PQGPPEIYSDTQFPS |
| 219 | HCFC2_553_567_Y560 | KSEVDETYALPATKI |
| 220 | HCK_404_418_Y411 | RVIEDNEYTAREGAK |
| 221 | HKS1 | AAEEIYAARRG |
| 222 | HNRPA2B1_312_326_Y319 | SRNMGGPYGGGNYGP |
| 223 | HNRPF_299_313_Y306 | KATENDIYNFFSPLN |
| 224 | HNRPH3_289_303_Y296 | GMDNQGGYGSVGRMG |
| 225 | HRIHFB2122_166_180_Y173 | GQRQALDYVELSPLT |
| 226 | HRMT1L2_292_306_Y299 | ST SPESPYTHWKQTV |
| 227 | HSP_CB_294_308_Y301 | DDITQEEYGEFYKSL |
| 228 | HSP_CB_477_491_Y484 | KETQKSIYYITGESK |
| 229 | ILF3_757_771_Y764 | QSYNQSPYSNYGPPQ |
| 230 | INSR_1183_1197_Y1190 | DIYETDYYRKGGKGL |
| 231 | IRS1_655_669_Y662 | QRVDPNGYMMMSP SG |
| 232 | IRS2_816_830_Y823 | CGGDSDQYVLMSSPV |
| 233 | ITGB4_1200_1214_Y1207 | GAQGEGPYSSLVSCR |
| 234 | IT_SN2_960_974_Y967 | REEPEALYAAVNKKP |
| 235 | JAK2_563_577_Y570 | VRREVGDYGQLHETE |
| 69 | K2C6E_53_65_S59 | GAGFGSRSLYGLG |
| 236 | KDR_Y1059 | DIYKDPDYVRKGDAR |
| 237 | KDR_Y996 | EEAPEDLYKDFLTLE |
| 238 | KIAA2002_1100_1114_Y1107 | PNPCSATYSNLGQSR |
| 239 | KIAA2002_634_648_Y641 | AYDNLAIYKSFLGTS |
| 240 | KIRREL_401_415_Y408 | TRVMKAIYSSFKDDV |
| 241 | KIRREL_550_564_Y557 | SGLERTPYEAYDPIG |
| 242 | KIT_Y703 | DHAEAALYKNLLHSK |
| 243 | KIT_Y721 | CSDSTNEYMDMKPGV |
| 244 | KIT_Y936 | SESTNHIYSNLANCS |
| 245 | KRT19_58_72_Y65 | SGGYGGGYGGVLTAS |
| 73 | LAT_249_261_Y255 | MESIDDYVNVPES |
| 246 | LAT2_186_200_Y193 | EDEESEDYQNSASIH |
| 247 | LDHB_233_247_Y240 | KMVVESAYEVIKLKG |
| 248 | LISCH7_302_316_Y309 | SIYAPSTYAHLSPAK |
| 249 | LLGL1_502_516_Y509 | KVGCFDPYSDDPRLG |
| 250 | LMO7_341_355_Y348 | RSWASPVYTEADGTF |
| 251 | LMO7_801_815_Y808 | IDATSGIYNSEKSSN |
| 252 | LPHN2_1343_1357_Y1350 | RSENEDIYYKSMPNL |
| 253 | LPP_268_282_Y275 | RGGMDYAYIPPPGLQ |
| 254 | LPP_294_308_Y301 | GRYYEGYYAAGPGYG |
| 255 | LYN_186_200_Y193 | RSLDNGGYYISPRIT |
| 256 | LYN_498_512_Y508 | DDFYTATEGQYQQQP |
| 257 | MAP_IB_1882_1896_Y1889 | PDEEDYDYESYEKTT |
| 258 | MAPK8_178_192_Y185 | TSFMMTPYVVTRYYR |
| 259 | MARCH7_308_322_Y315 | SLNSENSYVSPRILT |
| 260 | MARVELD2_7_21_Y14 | SRNRDRRYDEVPSDL |
| 261 | MATR3_212_226_Y219 | GYYDRMDYEDDRLRD |
| 76 | MBP_198_210_Y203 | ARTAHYGSLPQKS |
| 77 | MBP_259_271_Y261/Y268/S266 | FGYGGRASDYKSA |
| 62 | MCP_362_376_Y369 | KADGGAEYATYQTKS |
| 79 | MET_1227_1239_Y1230/Y1234/ | RDMYDKEYYSVHN |
| | Y1235 | |
| 263 | MET_Y1230 | FGLARDMYDKEYYSV |
| 87 | NPT2_501_513_T508 | AKALGKRTAKYRW |
| 264 | METAP_1_103_117_Y110 | PTRPVPSYIQRPDYA |
| 265 | METAP_1_92_106_Y99 | TGKLRPHYPLMPTRP |
| 80 | MK01_180_192_Y187 | HTGFLTEYVATRW |
| 83 | MK10_216_228_T221/Y223 | TSFMMTPYVVTRY |
| 266 | NAPG_298_312_Y307 | TAADEEEDEYSGGLC |
| 86 | NCF_1_313_325_S315/S320 | QRSRKRLSQDAYR |
| 129 | SYN1_2_14_S9 | NYLRRRLSDSNFM |
| 267 | NEK2_12_26_Y19 | YTIGTGSYGRCQKIR |
| 268 | NTE_1188_1202_Y1195 | FGKFDQIYDVGYQYG |
| 91 | NTRK2_699_711_Y702/Y706/Y707 | RDVYSTDYYRVGG |
| 94 | P2AB_297_309_T304/Y307 | EPHVTRRTPDYFL |
| 269 | P2RY2_223_237_Y230 | RRLLKPAYGTSGGLP |
| 95 | P85A_600_612_Y607/S608 | NENTEDQYSLVED |
| 270 | PABPC1_357_371_Y364 | IVATKPLYVALAQRK |
| 271 | PAG1_334_348_Y341 | LTVPESTYTSIQGDP |
| 272 | PAG1_352_366_Y359 | PSSCNDLYATVKDFE |
| 273 | PAG1_410_424_Y417 | LVPKENDYESISDLQ |
| 274 | PARD3_482_496_Y489 | IGGSAPIYVKNILPR |
| 96 | PAXI_11_123_Y118 | VGEEEHVYSFPNK |
| 97 | PAXI_24_36_Y31 | FLSEETPYSYPTG |
| 275 | PCM1_1169_1183_Y1176 | NSSGKTEYMAFPKPF |
| 276 | PCTK2_196_210_Y203 | EKLGEGTYATVYKGR |
| 277 | PDFGA_Y574 | PDGHEYIYVDPMQLP |
| 278 | PDFGA_Y768 | LYDRPASYKKKSMLD |
| 279 | PDFGB_Y1021 | PNEGDNDYIIPLPDP |
| 98 | PDPK1_2_14_Y9 | ARTTSQLYDAVPI |
| 99 | PDPK1_369_381_Y373/Y376 | DEDCYGNYDNLLS |
| 123 | STA5A_687_699_Y694 | LAKAVDGYVKPQI |
| 280 | | |
| 281 | PGM1_346_360_Y353 | SATKIALYETPTGWK |
| 282 | PIK3R1_303_317_Y310 | LRKTRDQYLMWLTQK |
| 283 | PIK3R2_598_612_Y605 | KNETEDQYALMEDED |
| 284 | PKP4_471_485_Y478 | ALNTTATYAEPYRPI |
| 285 | PLAGL1_17_31_Y24 | EKFTIHNYSHSRERP |
| 108 | PLCG1_764_776_Y771 | IGTAEPDYGALYE |
| 286 | PLEC1_3245_3259_Y3252 | RARQEELYSELQARE |
| 287 | PLEKHA6_485_499_Y492 | PPRSEDIYADPAAYV |
| 288 | PLEKHA7_463_477_Y470 | SLSFPENYQTLPKST |
| 289 | PRKCD_306_320_Y313 | SSEPVGIYQGFEKKT |
| 290 | PRKCD_327_341_Y334 | MQDNSGTYGKIWEGS |
| 110 | PRRX2_202_214_Y214 | WTASSPYSTVPPY |
| 291 | PSMA2_69_83_Y76 | TKHIGLVYSGMGPDY |
| 292 | PTK2_585_599_Y592 | GDFGLSRYMEDSTYY |
| 293 | PTK9_336_350_Y343 | ELTADFLYEEVHPKQ |
| 111 | PTN11_535_547_Y542 | SKRKGHEYTNIKY |
| 294 | PTPN11_573_587_Y580 | REDSARVYENVGLMQ |
| 295 | PTTG1_104_118_Y111 | VPASDDAYPEIEKFF |
| 112 | RAF1_331_343_S337/S338/Y339/ | RPRGQRDSSYYWE |
| | Y340 | |
| 113 | RASA1_453_465_Y460 | TVDGKEIYNTIRR |
| 114 | RB_804_816_S807/S811 | IYISPLKSPYKIS |
| 296 | RBM3_120_134_Y127 | SRPGGYGYGYGRSRD |
| 297 | RBMX_234_248_Y241 | YAPPPRDYTYRDYGH |
| 116 | RET_1022_1034_Y1029 | TP SDSLIYDDGLS |
| 298 | RET_Y1096 | RYPNDSVYANWMLSP |
| 299 | RICS_1673_1687_Y1680 | QYDNLEDYHSLPQHQ |
| 300 | RIPK2_374_388_Y381 | SRKAQDCYFMKLHHC |
| 118 | RON_1346_1358_Y1353 | SALLGDHYVQLPA |
| 126 | STAT3_698_710_Y705 | DPGSAAPYLKTKF |
| 301 | SACS_3345_3359_Y3352 | AKLEHLIYLKNRLSS |
| 302 | SCAMP3_79_93_Y86 | EPKNYGSYSTQASAA |
| 303 | SF3A3_472_486_Y479 | QPDTEEEYEDSSGNV |
| 304 | SHANK2_387_401_Y394 | GQMPENPYSEVGKIA |
| 305 | SHB_326_340_Y333 | KVTIADDYSDPFDAK |
| 306 | SHC1_233_247_Y240 | EPPDHQYYNDFPGKE |
| 307 | SIPA1L3_1162_1176_Y1169 | STPGSATYVRYKPSP |
| 308 | SLC20A2_370_384_Y377 | KPAQESNYRLLRRNN |
| 309 | SNIP_257_271_Y264 | IYRKEPLYAAFPGSH |
| 310 | SNRP70_139_153_Y146 | RSGKPRGYAFIEYEH |
| 311 | SNX3_15_29_Y22 | PQNLNDAYGPPSNFL |
| 312 | SORBS1_319_333_Y326 | RAEPKSIYEYQPGKS |
| 313 | SPAST_205_219_Y212 | SKSQTDVYNDSTNLA |
| 314 | SPRED2_261_275_Y268 | KHDYNYPYVDSSDFG |
| 315 | SPRY4_68_82_Y75 | TSHVENDYIDNPSLA |
| 316 | SRC_Y215 | KLDSGGFYITSRTQF |
| 121 | SRC8_CHICK_476_488_Y477/Y483 | EYEPETVYEVAGA |
| 317 | STAM_77_391_Y384 | EDPMYSMYAKLQNQP |
| 318 | STAM2_185_199_Y192 | HTETKSLYPSSEIQL |
| 319 | STAM2_364_378_Y371 | LVNEAPVYSVYSKLH |
| 320 | STAT3_697_711_Y704 | ADPGAAPYLKTKFIC |
| 131 | TEC_512_524_Y519 | RYFLDDQYTSSSG |
| 321 | TENC1_486_500_Y493 | GPLDGSPYAQVQRPP |
| 322 | TIGD1_232_246_Y239 | KLKPMLIYHSENPRA |
| 323 | TJP2_1111_1125_Y1118 | AQKHPDIYAVPIKTH |
| 324 | TJP2_499_513_Y506 | SPEDEAIYGPNTKMV |
| 325 | TJP3_390_404_Y397 | RESSYDIYRVPSSQS |
| 326 | TMEPAI_225_239_Y232 | MEGPPPTYSEVIGHY |
| 327 | TNS3_347_361_Y354 | GPVDGSLYAKVRKKS |
| 328 | TXNRD1_124_138_Y131 | KVVYENAYGQFIGPH |
| 329 | TXNRD1_145_159_Y152 | NKGKEKIYSAERFLI |
| 133 | TYRO3_679_691_Y686 | KIYSGDYYRQGCA |
| 330 | UBE2J1_1_15_Y5 | METRYNLKSPAVKRL |
| 100 | PECA1_706_718_Y713 | KKDTETVYSEVRK |
| 331 | VASP_32_46_Y39 | AFSRVQIYHNPTANS |
| 332 | VAV2_135_149_Y142 | TENDDDVYRSLEELA |
| 134 | VEGFR1_1049_1061_Y1053 | KNPDYVRKGDTRL |
| 136 | VEGFR2_944_956_Y951 | RFRQGKDYVGAIP |
| 333 | VEGFR3_Y1333 | ARGGQVFYNSEYGEL |
| 334 | VEGFR3_Y1337 | QVFYNSEYGELSEPS |
| 138 | VINC_815_827_Y821 | KSFLDSGYRILGA |
| 335 | | |
| 139 | ZAP70_485_497_Y492/Y493 | ALGADDSYYTARS |
| 140 | ZBT16_621_633_S628 | LRTHNGASPYQCT |
| 336 | ZNF326_129_143_Y136 | GSSWEAPYSRSKLRP |
| 337 | ZNF598_299_313_Y306 | GVVGGEDYEEVDRYS |

As used herein the peptide substrates are named as follows;

SwissProt Entry Name for the Human protein_Start position of the peptide within the full length protein_Stop position within the full length protein_Position of the tyrosine or serine that can be phosphorylated.

The porous matrix as used herein, could be any material having oriented through-going channels as are generally known in the art, such as for example described in PCT patent publication WO 01/19517 and is typically made from a metal oxide, glass, silicon oxide or cellulose. In a particular embodiment the porous material is made of a metal oxide selected from the group consisting of zinc oxide, zirconium oxide, tin oxide, aluminum oxide, titanium oxide and thallium; in a more particular embodiment the metal oxide consists of aluminum oxide.

The samples used in the methods of the invention could in principle be any biological sample, such as for example blood, urine, saliva, tissue biopsy or autopsy material and then in particular cell lysates thereof, but would typically consist of cell lysates prepared from cell lines, including cancer cell lines; primary and immortalized tissue cell lines; non-human animal model biopsies and patient biopsies. In one embodiment of the invention, the cell lysates are prepared from cancer cell lines; xenograft tumors or cancer patient biopsies, including tumor and normal tissue.

It will be appreciated that the preferred method for the pretreatment of the samples will depend on the particular compound to be tested, and the type of sample used. The optimum method can be readily determined by those skilled in the art using conventional methods and in view of the information set out herein. For example, in the treatment of cell lysates, the compound to be tested may be added to the cell lysate directly; in non-human animal models the compound to be tested will typically be administered at a therapeutically effective amount of the particular compound, optionally in addition salt form, and/or combined in intimate admixture with a pharmaceutically acceptable carrier, which may take a wide variety of forms depending on the form of preparation desired for administration. These pharmaceutical compositions are desirably in unitary dosage form suitable, preferably, for systemic administration such as oral, percutaneous, or parenteral administration; or topical administration such as via inhalation, a nose spray, eye drops or via a cream, gel, shampoo or the like. The optimum method and order of administration and the dosage amounts and regime can be readily determined by those skilled in the art and as provided in more detail in the examples hereinafter.

In those embodiments of the present invention where the methods according to the invention are used to pharmacologically profile kinase inhibitors, the array of substrates is contacted with the pretreated sample in the presence of the compound to be tested. It is accordingly an object of the present invention to provide a method for obtaining a pharmacological profile of a kinase inhibitor using an array of substrates immobilized on a porous matrix, said method comprising;
(i) contacting the array of substrates with a sample in the presence of the kinase inhibitor;
(ii) contacting the array of substrates with a sample in the absence of the kinase inhibitor;
(iii) determine the response of said array to the sample in step (i);
(iv) determine the response of said array to the sample in step (ii); and
   obtain the pharmacological profile as the difference in response of the array in steps (iii) and step (iv).

The response of the array of substrates is determined using a detectable signal, said signal resulting from the interaction of the sample with the array of substrates. As mentioned hereinbefore, in determining the interaction of the sample with the array of substrates the signal is either the result of a change in a physical or chemical property of the detectably labeled substrates, or indirectly the result of the interaction of the substrates with a detectably labeled molecule capable of binding to the substrates. For the latter, the molecule that specifically binds to the substrates of interest (e.g., antibody or polynucleotide probe) can be detectably labeled by virtue of containing an atom (e.g., radionuclide), molecule (e.g., fluorescein), or complex that, due to a physical or chemical property, indicates the presence of the molecule. A molecule may also be detectably labeled when it is covalently bound to or otherwise associated with a “reporter” molecule (e.g., a biomolecule such as an enzyme) that acts on a substrate to produce a detectable atom, molecule or other complex.

Detectable labels suitable for use in the present invention include any composition detectable by spectroscopic, photochemical, biochemical, immunochemical, electrical, optical or chemical means. Labels useful in the present invention include biotin for staining with labeled avidin or streptavidin conjugate, magnetic beads (e.g., Dynabeads'), fluorescent dyes (e.g., fluorescein, fluorescein-isothiocyanate (FITC), Texas red, rhodamine, green fluorescent protein, enhanced green fluorescent protein, lissamine, phycoerythrin, Cy2, Cy3, Cy3.5, Cy5, Cy5.5, Cy7, FluorX [Amersham], SyBR Green I & II [Molecular Probes], and the like), radiolabels (e.g., ³H, ¹²⁵I, ³⁵S, ¹⁴C, or ³²P), enzymes (e.g., hydrolases, particularly phosphatases such as alkaline phosphatase, esterases and glycosidases, or oxidoreductases, particularly peroxidases such as horse radish peroxidase, and the like), substrates, cofactors, inhibitors, chemiluminescent groups, chromogenic agents, and colorimetric labels such as colloidal gold or colored glass or plastic (e.g., polystyrene, polypropylene, latex, etc.) beads. Patents teaching the use of such labels include U.S. Pat. Nos. 3,817,837; 3,850,752; 3,939,350; 3,996,345; 4,277,437; 4,275,149; and 4,366,241.

Means of detecting such labels are well known to those of skill in the art. Thus, for example, chemiluminescent and radioactive labels may be detected using photographic film or scintillation counters, and fluorescent markers may be detected using a photodetector to detect emitted light (e.g., as in fluorescence-activated cell sorting). Enzymatic labels are typically detected by providing the enzyme with a substrate and detecting a colored reaction product produced by the action of the enzyme on the substrate. Colorimetric labels are detected by simply visualizing the colored label. Thus, for example, where the label is a radioactive label, means for detection include a scintillation counter, photographic film as in autoradiography, or storage phosphor imaging. Where the label is a fluorescent label, it may be detected by exciting the fluorochrome with the appropriate wavelength of light and detecting the resulting fluorescence. The fluorescence may be detected visually, by means of photographic film, by the use of electronic detectors such as charge coupled devices (CCDs) or photomultipliers and the like. Similarly, enzymatic labels may be detected by providing the appropriate substrates for the enzyme and detecting the resulting reaction product. Also, simple colorimetric labels may be detected by observing the color associated with the label. Fluorescence resonance energy transfer has been adapted to detect binding of unlabeled ligands, which may be useful on arrays.

In a particular embodiment of the present invention the response of the array of substrates to the sample is determined using detectably labeled antibodies; more in particular fluorescently labeled antibodies. In those embodiments of the invention where the substrates consist of kinase substrates, the response of the array of substrates is determined using fluorescently labeled anti-phosphotyrosine antibodies. As outlined in more detail in the examples hereinafter, the use of fluorescently labeled anti-phosphotyrosine antibodies allows real-time determination of the substrate activity and accordingly provides the possibility to express the array activity as the initial kinase velocity. In this embodiment the pharmacological profile is determined as the ratio of the array substrate response to the (pre)treated samples over the array substrate response to the untreated samples.

Hence, in a particular embodiment the present invention provides a method for obtaining a pharmacological profile of a kinase inhibitor using an array of substrates immobilized on a porous matrix, said method comprising;
(i) contacting the array of substrates with a sample in the presence of the kinase inhibitor;
(ii) contacting the array of substrates with a sample in the absence of the kinase inhibitor; (iii) determine the response of said array to the sample in step (i); (iv) determine the response of said array to the sample in step (ii); and
   obtain the pharmacological profile as the ratio of the array substrate response in step (iii) over the array substrate response in step (iv).

In a further aspect of this embodiment, and any of the embodiments of the invention;
the samples consist of cell lysates obtainable from any biological sample (supra), in particular cell lysates prepared from cancer cell lines; xenograft tumors or cancer patient biopsies, including tumor and normal tissue.
the array of substrates consist of kinase substrates, in particular peptide kinase substrates, more in particular comprising at least 2, 6, 12, 40, 50, 60, 70, 80, 90, 100, 110, 120, 130 or 140 peptides of the peptide kinase substrates of Table 1. In an even further embodiment the array of substrates comprising at least 2 peptides selected from the group consisting of peptides with sequence numbers 4, 19, 24, 69, 113, 114, 136 and 138, or from the group consisting of peptides with sequence numbers 15, 16, 22, 34, 62, 83, 86, 87, 100, 105, 108, 110, 113, 125, 129, and 133 or from the group consisting of peptides with sequence numbers 15, 16, 21, 23, 38, 42, 53, 62, 69, 77, 83, 86, 91, 94, 103, 112, 114, 129, 133, 136 and 138, or from the group consisting of peptides with sequence numbers 5, 10, 38, 30, 54, 57, 68, 72, 73, 74, 82, 91, 98, 99, 102, 104, 110, 135, 118, 119, 71, 138. Alternatively, the array of substrates consist of kinase substrates, more in particular peptide kinase substrates, even more particular the peptide kinase substrates in Table 2, most particular using at least 2, 6, 12, 16, 20, 24, 28, 32, 36, 40, 50, 60, 70, 80, 90, 100, 110, 120, 130, 150, 180, 200, 220 or 240 peptides of the peptide kinase substrates of Table 2. In an even further embodiment the array of substrates the array of substrates consist of the peptides with sequence numbers 142, 2, 163, 173, 177, 190, 161, 197, 207, 208, 213, 241, 73, 252, 255, 258, 262, 79, 87, 266, 86, 269, 95, 296, 303, 305, 308, and 138.
the response of the array of substrates is determined using antibodies, in particular fluorescently labeled antibodies, more in particular fluorescently labeled anti-phosphotyrosine antibodies; most particular using the commercially available PY20-FITC antibodies. It has been observed that the presence of antifungal compound, such as azoles or azide, in the sample could influence the array response, thus in a particular embodiment the response of the array of substrates is done using antibodies, in any of the above embodiments, in a solution free of antifungals, in particular using an azide free solution.
the samples are filtered prior to the incubation on the porous matrix, i.e. prior to the contacting of the substrate array with the samples in both steps (i) and (ii). Filtering of the samples is done using art known procedures, such as for example but not limited to filter membranes made from regenerated cellulose, cellulose esters, nylon, polypropylene, glass, anopore or teflon, typically the filter range should match the oriented through-going channels of the porous matrix, and is for example in the 10 to 0.1 micrometer range. In particular using an inorganic 0.2 micrometer filter, more in particular using an anopore 0.2 micrometer filter, as provided in the examples hereinafter.
the cell lysates used in step (i) are pre-incubated with the kinase inhibitor. It will be appreciated that the preferred method for the pre-incubation of the cell lysates will depend on the particular compound to be tested, and the type of cell lysates used. The optimum method can be readily determined by those skilled in the art using conventional methods, but would typically consist of incubating the cell lysates in the appropriate buffer, for example M-PER buffer (PIERCE) containing phosphatase and protease inhibitors, with the compound to be tested for a period in the range of 30 min-60 min. Again, the incubation is typically done on ice.

Hence, in a further embodiment the present invention provides a method for obtaining a pharmacological profile of a kinase inhibitor using an array of substrates immobilized on a porous matrix, said method comprising;
(i) obtain cell lysates prepared from cancer cell lines; xenograft tumors or cancer patient biopsies, including tumor and normal tissue;
(ii) filter the cell lysates over a filter in the 10 to 0.1 micrometer range;
(iii) incubate a fraction of said cell lysates with the kinase inhibitor to be tested;
(iv) contact the array of substrates in the presence of the kinase inhibitor to be tested, with the incubated fraction of step (iii);
(v) contact the array of substrates in the absence of the kinase inhibitor to be tested, with the fraction of cell lysates which was not incubated with the kinase inhibitor;
(vi) determine the response of said array in step (iv);
(vii) determine the response of said array in step (v); and
   obtain the pharmacological profile as the ratio of the array substrate response in step (iv) over the array substrate response in step (v).

In this embodiment, and any of the embodiments of the invention, one or more of the following further restrictions may apply;
the array of substrates consist of kinase substrates, in particular peptide kinase substrates, more in particular comprising at least 2, 6, 12, 40, 50, 60, 70, 80, 90, 100, 110, 120, 130 or 140 peptides of the peptide kinase substrates of Table 1. In an even further embodiment the array of substrates comprising at least 2 peptides selected from the group consisting of peptides with sequence numbers 4, 19, 24, 69, 113, 114, 136 and 138; from the group consisting of 15, 16, 21, 23, 38, 42, 53, 62, 69, 77, 83, 86, 91, 94, 103, 112, 114, 129, 133, 136 and 138, from the group consisting of 15, 16, 22, 34, 62, 83, 86, 87, 100, 105, 108, 110, 113, 125, 129, and 133 or from the group consisting of 5, 10, 38, 30, 54, 57, 68, 72, 73, 74, 82, 91, 98, 99, 102, 104, 110, 135, 118, 119, 71, 138. Alternatively, the array of substrates consist of kinase substrates, more in particular peptide kinase substrates, even more particular the peptide kinase substrates in Table 2, most particular using at least 2, 6, 12, 16, 20, 24, 28, 32, 36, 40, 50, 60, 70, 80, 90, 100, 110, 120, 130, 150, 180, 200, 220 or 240 peptides of the peptide kinase substrates of Table 2. In an even further embodiment the array of substrates consist of the peptides with sequence numbers 142, 2, 163, 173, 177, 190, 161, 197, 207, 208, 213, 241, 73, 252, 255, 258, 262, 79, 87, 266, 86, 269, 95, 296, 303, 305, 308, and 138.
the response of the array of substrates is determined using antibodies, in particular fluorescently labeled antibodies, more in particular fluorescently labeled anti-phosphotyrosine antibodies; most particular using the commercially available PY20-FITC antibodies. It has been observed that the presence of antifungal compound, such as azoles or azide, in the sample could influence the array response, thus in a particular embodiment the response of the array of substrates is done using antibodies, in any of the above embodiments, in a solution free of antifungals, in particular using an azide free solution.
Filtering of the samples is done using art known procedures, such as for example but not limited to filter membranes made from regenerated cellulose, cellulose esters, nylon, polypropylene, glass, anopore or teflon, typically the filter range should match the oriented through-going channels of the porous matrix, and is for example in the 10 to 0.1 micrometer range. In particular using an inorganic 0.2 micrometer filter, more in particular using an anopore 0.2 micrometer filter, as provided in the examples hereinafter.

In another embodiment, the present invention provides the use of the pharmacological profile determined using the methods of the invention, to enable the distinction between responders and non-responders in the treatment of cells, tissues, organs or warm-blooded animals with the compound to be tested. In particular to enable the distinction of responders from non-responders cell lines and tumors to the treatment with the compound to be tested.

As outlined in the examples hereinafter, it has also been an object of the present invention to provide the identification of specific sets of substrates, herein also referred to as “molecular signature” or “fingerprint’, on the substrate array of Table 1, that enables the distinction of responders from non-responders cell lines and tumors to the treatment with a class of macrocyclic quinazoline derivatives (I) below, described as multi targeted kinase inhibitors (MTKI) in PCT patent publication WO 2004/10765.

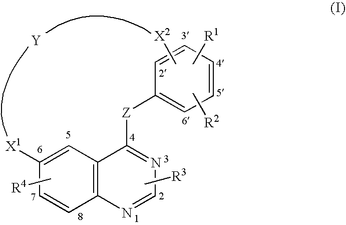

In particular to the treatment with a compound of formula (I) wherein;
Z represents NH;
Y represents —C₃₋₉alkyl-, —C₁₋₅alkyl-NR¹³—C₁₋₅alkyl-, —C₁₋₅alkyl-NR¹⁴—CO—C₁₋₅alkyl-, —C₁₋₃alkyl-NH—CO-Het²⁰-, or -Het²²-CH₂—CO—NH—C₁₋₃alkyl-;
X¹ represents O, or —O—C₁₋₂alkyl-;
X² represents a direct bond, —C₁₋₂alkyl-, O, —O—C₁₋₂alkyl-, NR¹² or NR¹²—C₁₋₂alkyl-;
R¹ represents hydrogen, cyano, halo or hydroxy, preferably halo;
R² represents hydrogen, cyano, halo, or hydroxy;
R³ represents hydrogen;
R⁴ represents C₁₋₄alkyloxy-;
R¹² represents hydrogen, or C₁₋₄alkyl-;
R¹³ represents hydrogen or C₁₋₄alkyl;
R¹⁴ represents hydrogen or C₁₋₄alkyl;
Het²⁰ represents pyrrolidinyl, piperazinyl or piperidinyl; and
Het²² represents pyrrolidinyl, piperazinyl or piperidinyl.

In particular to enable the distinction of responders from non-responders cell lines and tumors to the treatment with
4,6-ethanediylidenepyrimido[4,5-b][6,1,12]benzoxadiazacyclopentadecine, 17-bromo-8,9,10,11,12,13,14,19-octahydro-20-methoxy-13-methyl-(MTKI1); or the pharmaceutically acceptable acid or base addition salts thereof

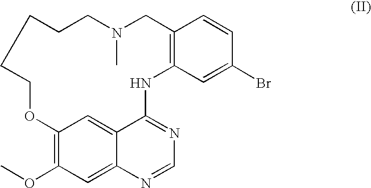

As used in the foregoing definitions and hereinafter,
halo is generic to fluoro, chloro, bromo and iodo;
C₁₋₂alkyl defines methyl or ethyl;
C₁₋₃alkyl defines straight and branched chain saturated hydrocarbon radicals having from 1 to 3 carbon atoms such as, for example, methyl, ethyl, propyl and the like;
C₁₋₄alkyl defines straight and branched chain saturated hydrocarbon radicals having from 1 to 4 carbon atoms such as, for example, methyl, ethyl, propyl, butyl, 1-methylethyl, 2-methylpropyl, 2,2-dimethylethyl and the like;
C₁₋₅alkyl defines straight and branched chain saturated hydrocarbon radicals having from 1 to 5 carbon atoms such as, for example, methyl, ethyl, propyl, butyl, pentyl, 1-methylbutyl, 2,2-dimethylpropyl, 2,2-dimethylethyl and the like;
C₃₋₉alkyl defines straight and branched chain saturated hydrocarbon radicals having from 3 to 9 carbon atoms such as propyl, butyl, pentyl, hexyl, heptyl, octyl, nonyl and the like;
C₁₋₄alkyloxy defines straight or branched saturated hydrocarbon radicals such as methoxy, ethoxy, propyloxy, butyloxy, 1-methylethyloxy, 2-methylpropyloxy and the like;
the term “CO” refers to a carbonyl group.

The pharmaceutically acceptable acid or base addition salts as mentioned hereinabove are meant to comprise the therapeutically active non-toxic acid and non-toxic base addition salt forms which MTKI 1 is able to form. The basic properties can be converted in their pharmaceutically acceptable acid addition salts by treating said base form with an appropriate acid. Appropriate acids comprise, for example, inorganic acids such as hydrohalic acids, e.g. hydrochloric or hydrobromic acid; sulfuric; nitric; phosphoric and the like acids; or organic acids such as, for example, acetic, propanoic, hydroxyacetic, lactic, pyruvic, oxalic, malonic, succinic (i.e. butanedioic acid), maleic, fumaric, malic, tartaric, citric, methanesulfonic, ethanesulfonic, benzenesulfonic, p-toluenesulfonic, cyclamic, salicylic, p-aminosalicylic, pamoic and the like acids.

The acidic properties may be converted in their pharmaceutically acceptable base addition salts by treating said acid form with a suitable organic or inorganic base. Appropriate base salt forms comprise, for example, the ammonium salts, the alkali and earth alkaline metal salts, e.g. the lithium, sodium, potassium, magnesium, calcium salts and the like, salts with organic bases, e.g. the benzathine, N-methyl-D-glucamine, hydrabamine salts, and salts with amino acids such as, for example, arginine, lysine and the like.

The terms acid or base addition salt also comprise the hydrates and the solvent addition forms which MTKI 1 is able to form. Examples of such forms are e.g. hydrates, alcoholates and the like.

Using the pharmacological profiling methods of the present invention (supra) with the substrates of Table 1, the “molecular signature” for MTKI1 was found to comprise at least 2 peptides selected from the group consisting of peptides with sequence numbers 15, 16, 22, 34, 62, 83, 86, 87, 100, 105, 108, 110, 113, 125, 129, and 133.

Using the pharmacological profiling methods of the present invention (supra) with the substrates of Table 2, the “molecular signature” for MTKI1 was found to comprise at least 2 peptides selected from the group consisting of peptides with sequence numbers 142, 2, 163, 173, 177, 190, 161, 197, 207, 208, 213, 241, 73, 252, 255, 258, 262, 79, 87, 266, 86, 269, 95, 296, 303, 305, 308, and 138.

It is accordingly an object of the present invention to provide a method to enable the distinction of responders from non-responders cell lines and tumors to the treatment with 4,6-ethanediylidenepyrimido[4,5-b][6,1,12]benzoxadiazacyclopentadecine, 17-bromo-8,9,10,11,12,13,14,19-octahydro-20-methoxy-13-methyl-(MTKI 1); or the pharmaceutically acceptable acid or base addition salts thereof; said method comprising;
(i) obtaining a sample from said cell lines and/or tumors;
(ii) contacting an array of substrates with said sample in the presence of MTKI1;
(iii) contacting an array of substrates with said sample in the absence of MTKI1;
(iv) determine the response of said array to the sample in step (ii);
(v) determine the response of said array to the sample in step (iii); and
   obtain the pharmacological profile as the ratio in response of the array in steps (iv) over step (v); characterized in that the array of substrates comprises at least 2 peptides selected from the group consisting of peptides with sequence numbers 4, 19, 24, 69, 113, 114, 136 and 138; and wherein a responder is identified as an inhibition (ratio<1.0) in response for at least two of the peptides selected from peptides with sequence numbers 15, 16, 22, 34, 62, 83, 86, 87, 100, 105, 108, 110, 113, 125, 129, and 133. In this embodiment, one or more of the following further restrictions may apply;
the array of substrates is immobilized on a matrix, more in particular on a porous matrix, such as for example, but not limited to any material having oriented through-going channels as are generally known in the art, such as for example described in PCT patent publication WO 01/19517 and is typically made from a metal oxide, glass, silicon oxide or cellulose. In a particular embodiment the porous material is made of a metal oxide selected from the group consisting of zinc oxide, zirconium oxide, tin oxide, aluminum oxide, titanium oxide and thallium; in a more particular embodiment the metal oxide consists of aluminum oxide;
the sample could in principle be any biological sample, such as for example blood, urine, saliva, tissue biopsy or autopsy material and then in particular cell lysates thereof, but would typically consist of cell lysates prepared from cell lines, including cancer cell lines; primary and immortalized tissue cell lines; non-human animal model biopsies and patient biopsies. In one embodiment of the invention, the cell lysates are prepared from cancer cell lines; xenograft tumors or cancer patient biopsies, including tumor and normal tissue;
the array of substrates comprising at least 3, 4, 5, 6 or 7 peptides selected from the group consisting of peptides with sequence numbers 15, 16, 22, 34, 62, 83, 86, 87, 100, 105, 108, 110, 113, 125, 129, and 133; in particular the array of substrates comprises the peptides with sequence numbers 15, 16, 22, 34, 62, 83, 86, 87, 100, 105, 108, 110, 113, 125, 129, and 133; more in particular the array of substrates consists of the peptides with sequence numbers 15, 16, 22, 34, 62, 83, 86, 87, 100, 105, 108, 110, 113, 125, 129, and 133;
the response of the array of substrates is determined using a detectable signal, said signal resulting from the interaction of the sample with the array of substrates. As mentioned hereinbefore, in determining the interaction of the sample with the array of substrates the signal is either the result of a change in the physical or chemical property of the detectably labeled substrates, or indirectly the result of the interaction of the substrates with a detectably labeled molecule capable of binding to the substrates. In an even further embodiment, the response of the array of substrates is determined using antibodies, in particular fluorescently labeled antibodies, more in particular fluorescently labeled anti-phosphotyrosine antibodies; most particular using the commercially available PY20-FITC antibodies. It has been observed that the presence of antifungal compound, such as azoles or azide, in the sample could influence the array response, thus in a particular embodiment the response of the array of substrates is determined using antibodies, in any of the above embodiments, in a solution free of antifungals, in particular using an azide free solution.
a responder is identified as an inhibition in response (ratio at least <0.80) for at least three of the peptides selected from peptides with sequence numbers 15, 16, 22, 34, 62, 83, 86, 87, 100, 105, 108, 110, 113, 125, 129, and 133.

The aforementioned method could optionally comprise one or more of the following additional steps;
an additional step in which a fraction of the sample is preincubated with MTKI1 prior to its application on the array of substrates.
an additional step in which the samples are filtrated prior to their application on the array of substrates. Filtering of the samples is done using art known procedures, such as for example but not limited to filter membranes made from regenerated cellulose, cellulose esters, nylon, polypropylene, glass, anopore or teflon, typically the filter range should match the oriented through-going channels of the porous matrix, and is for example in the 10 to 0.1 micrometer range. In particular using an inorganic 0.2 micrometer filter, more in particular using an anopore 0.2 micrometer filter, as provided in the examples hereinafter.

### EXPERIMENTAL DATA AND EXAMPLES

### Materials and Methods

### The Use of PAMCHIPs in Prediction of Drug Response and in Compound Differentiation.

PAMGENE technology using the tyrosine peptide PAMCHIP96 allows the kinetic detection of the phosphorylation of 144 tyrosine peptides spotted onto a 3-dimensional porous well of a 96-well plate (www.pamgene.com). This technology can be used to measure the activity of purified kinases and the effects of kinase inhibitors thereon. Phosphotyrosine peptides are detected using a mix of fluorescently labeled anti-phosphotyrosine antibodies. Phosphorylation of peptides can be followed in real time due to the possibility of removing the reaction mix for a few seconds during the assay by a pumping mechanism to allow CCD camera detection of phosphopeptides bound to the fluorescent antibody. These consecutive datapoints (quantified spot images) generate a kinetic curve for each individual peptide, and allow for the calculation of initial velocities and endpoints associated with each individual peptide.

This technology has been modified to enable profiling of tyrosine kinase activities in untreated and compound-treated lysates (lysates prepared from cancer cell lines, xenograft tumors and patient biopsies, tumor and normal tissue, can all be used), as well as treated and untreated cell lines. The use of these profiles was demonstrated in stratifying compound responder from non responders cell lines and tumors, as well as in the differentiation of tyrosine kinase inhibitors based on their target selectivity and ATP competitiveness, as well as in characterizing the indirect effect of non-kinase inhibitors (such as histone deacetylase inhibitors) on kinase activity.

### Cultured Cell Lysates

Cells cultured in appropriate medium in T175 flasks, treated with compound if necessary, are harvested at 70-90% confluency.

Media is removed, cells are washed with 10 ml ice cold PBS containing 0.1 mM NaVO₄ and lysed in 1 ml of M-PER buffer (PIERCE) containing phosphatase and protease inhibitors (HALT, PIERCE). Cells are collected by scraping, and centrifuged for 10 minutes at 12 000×g. Supernatant lysates are filtered through a 0.2 micrometer filter (Anotop 0.2 μm anopore filter; Whatmann). Lysates are flash frozen in liquid nitrogen and stored at −80C.

### Tumor and Tissue Lysates

100 mg of frozen tumor or tissue blocks, or sections, are lysed in 1 ml of M-PER buffer (PIERCE) containing phosphatase and protease inhibitors (HALT, PIERCE). The suspension is mixed using a ULTRA-TURRAX blender (IKA werke), and centrifuged twice for 10 minutes at 12 000×g. Supernatant lysates are filtered through a 0.2 micrometer filter (Anotop 0.2 μm anopore filter; Whatmann). Lysates are flash frozen in liquid nitrogen and stored at −80C.

### PAMCHIP Procedure

Just prior to the PAMCHIP experiment, total protein content is quantitated in the lysates and lysates are diluted to 1 mg/ml in a total volume of 200 μl, with M-PER phosphatase and protease inhibitors (HALT, PIERCE). 10 μg of total lysate (corresponding to 10 μl) will be used per well on the PAMCHIP96.

To all 200 μl lysates 10 units of benzonase (Novagen) is added and lysates are further incubated for 30 min on ice and next centrifuged for 10 minutes at 12 000×g. The supernatant is then 1:1 diluted with compound or DMSO diluted to the appropriate concentration in water, and lysates are further incubated exactly 60 min on ice. Meanwhile, a PAMCHIP96 tyrosine peptide chip (PAMGENE) is blocked with 2% BSA (filtered through a 0.2 μm anopore filter; Whatmann) using the standard setting of a PAMSTATION96 (PAMGENE).

The composition of the kinase buffer is as follows: 1×ABL buffer (NEB), 0.5 mg/ml BSA (from 10 mg/ml NEB stock), 100 μM ATP (dissolved and diluted in 1×ABL buffer), 5 μg/ml PY20-FITC (ExAlpha Biologicals, azide-free preparation). A twofold concentrated kinase buffer is prepared chilled on ice, DMSO or compound is added as appropriate, and the solution is added 1:1 to the (compound treated) ice cold lysates, and immediately applied to a tyrosine peptide PAMCHIP96. The assay is run on a PAMSTATION96 according to standard procedures: after loading of the plate, solution is pumped once onto the wells, a first exposure is read (150 mSec) and then a kinetic reading program (reading every 5 min for 150 mSec) is run for 60 min. Lysates are run in 6 technical replicates for each condition; replicates are always applied horizontally next to each other to avoid vertical strip effects of the chip.

### Data Analysis

### Preprocessing.

The data (spot images) are further quantified and linked to the peptide identities using EVOLVE PAMGRID software (PAMGENE). The quantified data are then fit to a curve using CurveFitHT software (PAMGENE) using the Vinip2 curve fitting algorithm, applied on the first 30 min of the assay; the initial velocity is derived at the first kinetic time point read. All subsequent data analyses were done on initial velocities (Vini) using the software packages Omniviz and R (Ihaka, R. and Gentlemen, R. (1996) R: a language for data analysis and graphics. J. Comput. Graph. Stat., 5, 299-314).

### Testing for Differentially Inhibited Peptides.

After replacing the Vini's lower than 0.1 by 0.1, all Vini's were log 2-transformed to approach normality. Subsequently, it was tested whether the compound-induced reduction in Vini's differed significantly between responding and non-responding tumors. This test was done for each peptide separately using a mixed model (Littell, R. C., Milliken, G. A., Stroup, W. W., Wolfinger, R. D. 1996. SAS system for mixed models. Cary, N. C.: SAS Institute Inc.) allowing the incorporation of both technical variation (i.e., the variation across replicates) and biological variation (i.e., the variation among the various responding and non-responding cell lines or tumors). Variation between cell lines or tumors in Vini and in treatment effect on Vini was modeled respectively by random intercepts and random compound effects per cell line or tumor, nested in response status. The difference in compound-induced reduction in Vini between responding and non-responding cell lines or tumors was tested through the interaction between compound treatment and response status, both modeled as fixed effects. The p-values for the test for this interaction were corrected for multiple testing using False Discovery Rate procedure (Benjamini, Y. and Hochberg, Y. 1995. Controlling the False Discovery Rate: A Practical and Powerful Approach to Multiple Testing. J. Roy. Stat. Soc. B, 57(1): 289-300), resulting in so-called q-values.

### Example 1

### Generation of Signature Peptides in a 27-Cell Lines Panel for MTKI

It was tested whether the Pamchip peptide arrays are a useful tool to predict the response of a cell line to the multi-targeted kinase inhibitor, MTKI. MTKI inhibits the proliferation of a range of cell lines in vitro with widely varying IC₅₀'s. The lysates prepared from these 27 cell lines, representing diverse cancer cell types, were profiled on the peptide arrays in the absence or presence of 5 μM MTKI, in 6 replicates for each condition. In this panel, 13 cell lines were defined as responder cell lines (IC₅₀<3 μM; cell lines are ordered according to increasing IC50 in Example 1, whereas 14 cell lines are classified as ‘non-responder’ cell lines (IC₅₀>10 μM). Intermediary cell lines and cell lines with highly variable IC₅₀ measurements were omitted from the analysis. The experiment included the highly responsive H3255 lung cancer cell line, which overexpresses mutant EGFR L858R. This mutant variant is highly responsive to MTKI, which is an ATP-competitive compound that binds to the active conformation of EGFR (similar to erlotinib and gefitinib). Accordingly, the most profound changes induced by MTKI in lysate kinase activity can be observed for this highly responsive cell line. To identify those peptides for which the inhibition of phosphorylation by MTKI correlates well with the response status of the cell line from which the lysate was prepared, a statistical mixed-model was set up to identify those peptides that are most likely to change after MTKI treatment in responder cell lysates compared to non-responder lysates, taken into account the inter-replicate variability (see the material and methods section for a more detailed description of the statistical test). The 16 peptides that are most likely to change by MTKI treatment in responders versus non-responders are listed in Example 1, using a cut-off p-value of 0.01 (correction for the large number of repeated measurements in this statistical analysis indicates that this p-value translates to a q value of 0.1). To illustrate that the inhibition of the phosphorylation of these peptides in a given lysate does indeed correlate with the response of the corresponding cell line to MTKI, the following cut-off was chosen to classify responders and non-responders: minimally 4 peptides out of the 16 peptide list should be inhibited with a ratio of less than 0.8 (more than 20% inhibition) to classify as a responder. Applying this rule to all 27 cell lines indicates an overall classification accuracy of 82% (with 78% sensitivity, and 86% specificity). Interestingly, two out of three responders that are falsely predicted as non-responders (Colo699 and H2009) have the highest IC50 of all 13 responders (i.e. these are ‘borderline’ responders). Note that the use of these 20 peptides as a classification tool can be optimized according to the required sensitivity and specificity.

Results represented by the ratio of initial velocity of peptide phosphorylation in the presence of solvent (DMSO) over the initial velocity of peptide phosphorylation in the presence of MTKI are shown in Tables 3 A to D.; ′NaN indicates that there is no detectable phosphorylation in the presence of DMSO

In order to adapt the sensitivity or specificity to specific needs (e.g. to eliminate false positives or alternatively false negatives as much as possible), the skilled person can adapt the prediction statistics easily, e.g. by changing the Responder prediction ratio.

TABLE 3A

| | H3255 | NCI-N87 | H322 | SNU484 | H2122 | SKBR3 | A431 |
|---|---|---|---|---|---|---|---|
| peptides | MTKI | MTKI | MTKI | MTKI | MTKI | MTKI | MTKI |
| CDK7_157_169_S164 | 0.55 | 0.82 | 0.88 | 0.67 | 0.90 | 0.97 | 0.53 |
| CREB1_122_134_Y134/S133 | 0.73 | 0.82 | 0.94 | 0.70 | 0.85 | 0.99 | 0.63 |
| DDR2_733_745_Y740 | 0.44 | 0.95 | 0.85 | 0.75 | 0.81 | 0.93 | 0.56 |
| ENOG_37_49_Y43 | 0.76 | 0.91 | 0.76 | 0.68 | 0.71 | 0.77 | 0.83 |
| GSK3B_209_221_Y216 | 0.60 | 0.83 | 0.94 | 0.78 | 0.84 | 0.89 | 0.56 |
| MK10_216_228_T221/Y223 | 0.47 | 0.73 | 0.76 | 0.72 | 0.79 | 0.68 | 0.46 |
| NCF1_313_325_S315/S320 | 0.59 | 0.89 | 0.88 | 0.80 | 0.94 | 0.94 | 0.57 |
| NPT2_501_513_T508 | 0.68 | 0.88 | 0.88 | 0.85 | 0.90 | 0.77 | 0.53 |
| PECA1_706_718_Y713 | 0.68 | 0.82 | 0.73 | 0.64 | 0.67 | 0.68 | 0.72 |
| PGFRB_768_780_Y771/Y775/ | 0.12 | 0.32 | 0.92 | NaN | NaN | NaN | 0.97 |
| Y778 | | | | | | | |
| PLCG1_764_776_Y771 | 0.97 | 0.78 | 0.79 | 0.70 | 0.76 | 0.75 | 0.82 |
| PRRX2_202_214_Y214 | 0.67 | 0.82 | 0.85 | 0.67 | 0.84 | 0.75 | 0.75 |
| RASA1_453_465_Y460 | 0.65 | 0.59 | 0.83 | 0.58 | 0.78 | 0.88 | 0.62 |
| STAT2_683_695_Y690 | 0.72 | 0.83 | 0.89 | 0.73 | 0.90 | 0.81 | 0.57 |
| SYN1_2_14_S9 | 0.70 | 0.75 | 0.91 | 0.67 | 0.91 | 1.03 | 0.58 |
| TYRO3_679_691_Y686 | 0.47 | 0.85 | 0.96 | 0.85 | 0.95 | 0.90 | 0.52 |
| status | R | R | R | R | R | R | R |
| prediction | R | R | R | R | R | R | R |

TABLE 3B

| | SUM159 | BT474OD | DU145 | SUM149 | H2009 | Colo699 | HT1373 |
|---|---|---|---|---|---|---|---|
| peptides | MTKI | MTKI | MTKI | MTKI | MTKI | MTKI | MTKI |
| CDK7_157_169_S164 | 0.83 | 0.74 | 0.63 | 0.72 | 0.89 | 0.93 | 1.10 |
| CREB1_122_134_Y134/S133 | 1.03 | 0.90 | 0.93 | 0.88 | 0.97 | 0.86 | 0.95 |
| DDR2_733_745_Y740 | 0.83 | 0.83 | 0.71 | 0.83 | 0.95 | 1.20 | 0.92 |
| ENOG_37_49_Y43 | 0.82 | 0.55 | 0.65 | 0.91 | 0.81 | 0.86 | 0.87 |
| GSK3B_209_221_Y216 | 1.13 | 0.87 | 0.94 | 0.41 | 1.00 | 1.03 | 0.97 |
| MK10_216_228_T221/Y223 | 0.89 | 0.76 | 0.66 | 0.79 | 0.89 | 0.86 | 0.87 |
| NCF1_313_325_S315/S320 | 0.99 | 0.88 | 0.87 | 1.06 | 0.89 | 0.93 | 1.02 |
| NPT2_501_513_T508 | 0.98 | 0.77 | 0.90 | 0.78 | 0.76 | 0.95 | 1.00 |
| PECA1_706_718_Y713 | 0.87 | 0.51 | 0.73 | 0.87 | 0.79 | 0.83 | 0.86 |
| PGFRB_768_780_Y771/Y775/ | NaN | NaN | 0.39 | 0.58 | 0.43 | 0.23 | NaN |
| Y778 | | | | | | | |
| PLCG1_764_776_Y771 | 0.79 | 0.68 | 0.76 | 0.95 | 0.81 | 0.78 | 0.76 |
| PRRX2_202_214_Y214 | 0.84 | 0.56 | 0.68 | 0.71 | 0.90 | 0.76 | 0.91 |
| RASA1_453_465_Y460 | 0.82 | 0.61 | 0.69 | 0.93 | 0.83 | 0.81 | 0.78 |
| STAT2_683_695_Y690 | 1.09 | 0.91 | 0.93 | 0.89 | 0.84 | 0.93 | 0.97 |
| SYN1_2_14_S9 | 1.03 | 0.94 | 0.92 | 1.02 | 0.93 | 0.95 | 0.92 |
| TYRO3_679_691_Y686 | 0.87 | 0.88 | 0.68 | 0.76 | 0.89 | 1.18 | 0.87 |
| status | R | R | R | R | R | R | NR |
| prediction | NR | R | R | R | NR | NR | NR |

TABLE 3C

| | MDAMB435s | RSJSA1 | HEK239 | H23 | SHSY5Y | H1650 | MDA231PAR |
|---|---|---|---|---|---|---|---|
| peptides | MTKI | MTKI | MTKI | MTKI | MTKI | MTKI | MTKI |
| CDK7_157_169_S164 | 1.08 | 0.81 | 1.20 | 0.92 | 0.97 | 0.82 | 1.13 |
| CREB1_122_134_Y134/S133 | 1.09 | 0.99 | 1.08 | 1.02 | 1.17 | 0.88 | 1.04 |
| DDR2_733_745_Y740 | 1.07 | 1.02 | 1.00 | 0.81 | 1.01 | 0.85 | 1.11 |
| ENOG_37_49_Y43 | 0.84 | 0.95 | 0.96 | 0.80 | 0.99 | 0.73 | 0.93 |
| GSK3B_209_221_Y216 | 1.14 | 1.11 | 1.18 | 1.09 | 0.87 | 0.79 | 0.98 |
| MK10_216_228_T221/Y223 | 1.29 | 0.96 | 0.75 | 0.98 | 1.10 | 0.69 | 0.83 |
| NCF1_313_325_S315/S320 | 1.09 | 1.00 | 0.96 | 0.86 | 1.26 | 0.92 | 1.03 |
| NPT2_501_513_T508 | 1.05 | 0.96 | 0.89 | 0.91 | 1.17 | 0.91 | 1.09 |
| PECA1_706_718_Y713 | 0.76 | 0.85 | 1.00 | 0.62 | 0.96 | 0.70 | 0.86 |
| PGFRB_768_780_Y771/Y775/ | NaN | NaN | NaN | NaN | NaN | 0.32 | NaN |
| Y778 | | | | | | | |
| PLCG1_764_776_Y771 | 0.98 | 0.90 | 1.02 | 0.84 | 0.96 | 0.84 | 0.93 |
| PRRX2_202_214_Y214 | 1.03 | 1.03 | 1.30 | 0.67 | 0.92 | 0.91 | 0.97 |
| RASA1_453_465_Y460 | 0.88 | 1.17 | 0.89 | 0.71 | 0.87 | 0.98 | 0.80 |
| STAT2_683_695_Y690 | 1.09 | 1.03 | 1.03 | 0.93 | 1.17 | 0.85 | 1.00 |
| SYN1_2_14_S9 | 1.12 | 1.05 | 0.92 | 1.01 | 1.11 | 0.83 | 0.92 |
| TYRO3_679_691_Y686 | 0.93 | 1.22 | 0.93 | 1.10 | 0.95 | 0.90 | 0.99 |
| status | NR | NR | NR | NR | NR | NR | NR |
| prediction | NR | NR | NR | NR | NR | R | NR |

TABLE 3D

| | MOLT4 | MCF7 | MKN45 | SNU5 | GTL16 | U118MG |
|---|---|---|---|---|---|---|
| peptides | MTKI | MTKI | MTKI | MTKI | MTKI | MTKI |
| CDK7_157_169_S164 | 0.91 | 0.89 | 0.90 | 0.98 | 0.98 | 0.85 |
| CREB1_122_134_Y134/S133 | 1.02 | 0.85 | 0.94 | 1.01 | 0.91 | 0.99 |
| DDR2_733_745_Y740 | 0.78 | 1.15 | 0.94 | 0.95 | 1.00 | 1.00 |
| ENOG_37_49_Y43 | 0.77 | 0.83 | 0.91 | 0.81 | 0.80 | 0.85 |
| GSK3B_209_221_Y216 | 1.19 | 0.89 | 0.99 | 0.98 | 1.11 | 1.06 |
| MK10_216_228_T221/Y223 | 0.85 | 1.03 | 0.95 | 0.99 | 0.96 | 0.97 |
| NCF1_313_325_S315/S320 | 1.18 | 0.90 | 0.95 | 0.99 | 0.96 | 1.05 |
| NPT2_501_513_T508 | 0.96 | 0.90 | 0.97 | 0.98 | 0.89 | 0.94 |
| PECA1_706_718_Y713 | 0.77 | 0.74 | 0.83 | 0.81 | 0.95 | 0.92 |
| PGFRB_768_780_Y771/Y775/ | 0.17 | NaN | 1.04 | 0.89 | 0.75 | NaN |
| Y778 | | | | | | |
| PLCG1_764_776_Y771 | 0.80 | 0.78 | 0.92 | 0.84 | 0.90 | 0.91 |
| PRRX2_202_214_Y214 | 0.72 | 0.90 | 1.04 | 0.89 | 0.97 | 1.03 |
| RASA1_453_465_Y460 | 0.79 | 0.81 | 0.92 | 0.92 | 0.81 | 0.94 |
| STAT2_683_695_Y690 | 0.95 | 0.91 | 0.97 | 0.91 | 1.06 | 0.97 |
| SYN1_2_14_S9 | 1.22 | 0.92 | 0.94 | 1.01 | 0.91 | 1.02 |
| TYRO3_679_691_Y686 | 0.97 | 0.98 | 1.00 | 0.89 | 0.92 | 0.91 |
| status | NR | NR | NR | NR | NR | NR |
| prediction | R | NR | NR | NR | NR | NR |

R = Responder to MTKI
NR = Non-Responder to MTKI
A responder is predicted when minimally 4 peptides have a ratio <0.8 (indicated in bold)
Overall prediction accuracy:: 82% (22/27)
Sensitivity (number of predicted Responders over number of actual Responders): 78% (10/13)
Specificity (number of predicted Non-Responders over number of actual Non-Responders): 86% (12/14)

### Example 2

### Generation of Signature Peptides in Xenograft Tumors for MTKI

To explore whether a similar approach allows for the classification of responder and non-responder tumors, the same strategy as above was applied to 12 different xenograft tumors, which were subcutaneously grown in nude immuno-compromised mice from human cancer cell lines. These tumors can be divided in 6 responsive tumors and 6 non-responsive tumors. The responsive tumors are arranged according to their responsiveness to MTKI in vivo, ranging from abrupt tumor regression of H3255, A431 and H322 tumors, to potent inhibition of tumor growth for DU145, SUM149 and BT474. The non-responsive tumors (H460 and H441, HT29, PC3, SKOV3, H1703) are all non-responsive to MTKI in vivo. Lysates were made from homogenized frozen tumor blocks and analyzed in the absence or presence of 5 μM MTKI, as before. Overall, the phosphorylation rate of most peptides was significantly faster in tumor lysates compared to the corresponding cell lines. Nevertheless, inhibition of peptide phosphorylation profiles indicated that there is a subset of peptides for which the inhibition of phosphorylation correlated with responsiveness of the tumors to MTKI. A statistical test was applied to this data set—similar as before for the 27 cell lines—and the 21 peptides that best discriminate between responders and non-responders is shown in Tables 4A and B. The cut-off p-value used for this set is 0.1. Note that the p-values for these peptides to discriminate between responders and non-responder tumors are significantly lower than those derived for the cell lines because the number of tumors (12) is far lower then the number of cell lines in Example 1 (27). Note that 7 of the peptides in this tumor signature set were also found in the 16-peptide cell line signature set (Example 1) indicating that inhibition of some of the same activities are critical to reduce tumor growth in vivo as compared to inhibition of growth in vitro, but also pointing to the importance of other kinases in the in vivo setting. Importantly, for many signature peptides the extent of inhibition correlated with the responsiveness of the tumor to MTKI.

Results represented by the ratio of initial velocity of peptide phosphorylation in the presence of solvent (DMSO) over the initial velocity of peptide phosphorylation in the presence of MTKI are shown in Tables 4A-B.; ′NaN indicates that there is no detectable phosphorylation in the presence of DMSO

In order to adapt the sensitivity or specificity to specific needs (e.g. to eliminate false positives or alternatively false negatives as much as possible), the skilled person can adapt the prediction statistics easily, e.g. by changing the Responder prediction ratio.

TABLE 4A

| | H3255 | A431 | H322 | DU145 | SUM149 | BT474 |
|---|---|---|---|---|---|---|
| Peptide | MTKI | MTKI | MTKI | MTKI | MTKI | MTKI |
| CDK7_157_169_S164 | 0.45 | 0.60 | 0.77 | 0.96 | 0.93 | 0.88 |
| CREB1_122_134_Y134/S133 | 0.61 | 0.67 | 0.80 | 0.93 | 1.02 | 1.02 |
| DDR1_785_797_Y792/Y796/Y797 | 0.48 | 0.58 | 0.71 | 0.64 | 0.88 | 0.94 |
| DYR1A_212_224_Y219 | 0.62 | 0.03 | 0.59 | 0.90 | 0.10 | 0.07 |
| EPHA4_589_601_Y596 | 0.44 | 0.51 | 0.63 | 0.77 | 1.03 | 0.79 |
| EPHB1_921_933_Y928 | 0.44 | 0.39 | 0.75 | 0.81 | 0.85 | 0.70 |
| FAK1_569_581_Y576/Y577 | 0.48 | 0.58 | 0.82 | 0.72 | 0.94 | 0.89 |
| GSK3B_209_221_Y216 | 0.57 | 0.67 | 0.77 | 1.07 | 0.91 | 0.89 |
| K2C6E_53_65_S59 | 0.56 | 0.54 | 0.80 | 0.77 | 0.86 | 0.80 |
| MBP_259_271_Y261/Y268/S266 | 0.47 | 0.60 | 0.65 | 0.81 | 1.04 | 0.85 |
| MK10_216_228_T221/Y223 | 0.31 | 0.60 | 0.68 | 0.77 | 0.75 | 0.83 |
| NCF1_313_325_S315/S320 | 0.73 | 0.66 | 0.78 | 0.97 | 0.94 | 1.02 |
| NTRK2_699_711_Y702/Y706/Y707 | 0.48 | 0.46 | 0.76 | 0.77 | 0.85 | 0.77 |
| P2AB_297_309_T304/Y307 | 0.66 | 0.65 | 0.77 | 0.81 | 0.87 | 0.62 |
| PGFRB_572_584_Y579/Y581 | 0.66 | 0.64 | 0.67 | 0.72 | 0.69 | 0.75 |
| RAF1_331_343_S337/S338/Y339/Y340 | 0.53 | 0.58 | 0.79 | 0.83 | 0.99 | 0.94 |
| RB_804_816_S807/S811 | 0.52 | 0.53 | 0.75 | 0.76 | 0.83 | 0.80 |
| SYN1_2_14_S9 | 0.50 | 0.76 | 0.78 | 0.88 | 1.01 | 0.96 |
| TYRO3_679_691_Y686 | 0.51 | 0.55 | 0.80 | 0.83 | 1.03 | 0.84 |
| VEGFR2_944_956_Y951 | 0.52 | 0.58 | 0.75 | 0.95 | 0.86 | 0.84 |
| VINC_815_827_Y821 | 0.40 | 0.52 | 0.76 | 0.84 | 0.75 | 0.85 |
| response status | R | R | R | R | R | R |
| response prediction | R | R | R | R | NR | NR |

TABLE 4B

| | SKOV | PC3 | H460 | H441 | HT29 | H1703 |
|---|---|---|---|---|---|---|
| Peptide | 3MTKI | MTKI | MTKI | MTKI | MTKI | MTKI |
| CDK7_157_169_S164 | 0.89 | 0.82 | 0.98 | 0.93 | 0.96 | 0.77 |
| CREB1_122_134_Y134/S133 | 1.03 | 0.86 | 1.02 | 0.95 | 1.00 | 0.93 |
| DDR1_785_797_Y792/Y796/Y797 | 0.87 | 0.83 | 1.01 | 0.77 | 0.85 | 0.96 |
| DYR1A_212_224_Y219 | 0.67 | 0.44 | NaN | 0.83 | 0.50 | NaN |
| EPHA4_589_601_Y596 | 1.20 | 0.83 | 2.10 | 0.86 | 1.08 | 0.87 |
| EPHB1_921_933_Y928 | 0.77 | 0.81 | 1.01 | 0.85 | 1.03 | 0.64 |
| FAK1_569_581_Y576/Y577 | 0.88 | 0.83 | 1.12 | 0.82 | 0.77 | 0.73 |
| GSK3B_209_221_Y216 | 1.06 | 0.77 | 0.95 | 0.97 | 0.98 | 0.98 |
| K2C6E_53_65_S59 | 0.85 | 0.71 | 0.97 | 0.79 | 0.82 | 0.94 |
| MBP_259_271_Y261/Y268/S266 | 1.16 | 0.84 | 1.02 | 0.79 | 0.89 | 0.89 |
| MK10_216_228_T221/Y223 | 0.84 | 0.67 | 0.96 | 0.85 | 0.73 | 0.84 |
| NCF1_313_325_S315/S320 | 0.91 | 0.83 | 1.01 | 0.93 | 0.92 | 0.95 |
| NTRK2_699_711_Y702/Y706/Y707 | 0.77 | 0.73 | 0.99 | 0.80 | 0.87 | 0.88 |
| P2AB_297_309_T304/Y307 | 1.37 | 0.84 | 1.06 | 0.92 | 1.00 | 0.88 |
| PGFRB_572_584_Y579/Y581 | 0.61 | 0.62 | 1.12 | 0.74 | 0.68 | 0.77 |
| RAF1_331_343_S337/S338/Y339/Y340 | 1.01 | 0.85 | 1.03 | 0.88 | 0.97 | 0.94 |
| RB_804_816_S807/S811 | 0.94 | 0.61 | 0.96 | 0.82 | 0.75 | 0.86 |
| SYN1_2_14_S9 | 1.00 | 0.75 | 1.07 | 0.98 | 1.01 | 0.91 |
| TYRO3_679_691_Y686 | 0.98 | 0.81 | 1.03 | 0.83 | 0.92 | 0.95 |
| VEGFR2_944_956_Y951 | 0.90 | 0.77 | 0.91 | 0.91 | 1.01 | 0.82 |
| VINC_815_827_Y821 | 0.79 | 0.66 | 0.85 | 0.88 | 0.89 | 0.80 |
| response status | NR | NR | NR | NR | NR | NR |
| response prediction | NR | R | NR | NR | NR | NR |

R = Responder to MTKI
NR = Non-Responder to MTKI
A Responder is predicted when minimally 7 peptides have a ratio <0.8 (indicated in bold font).
Overall prediction accuracy: 9/12 (75%)
Sensitivity (number of predicted Responders over number of actual Responders): 4/6 (67%).
Specificity (number of predicted Non-Responders over number of actual Non-Responders): 5/6 (83%).

### Example 3

### Human Frozen Tissue and Tumor Samples

The same approach as for the xenograft tumor lysates was applied to human tissue (frozen tissue purchased from Proteogenex). Snap-frozen lung tumors and normal matched tissue were tested. It was found that all samples gave robust signals, and that different tumors resulted in different responses to MTKI1 treatment, suggesting that this technology is applicable to frozen human tissue in general and may predict response of tumors (and other tissue) to MTKI1 or other tyrosine kinase inhibitors.

### Example 4

### Compound Differentiation

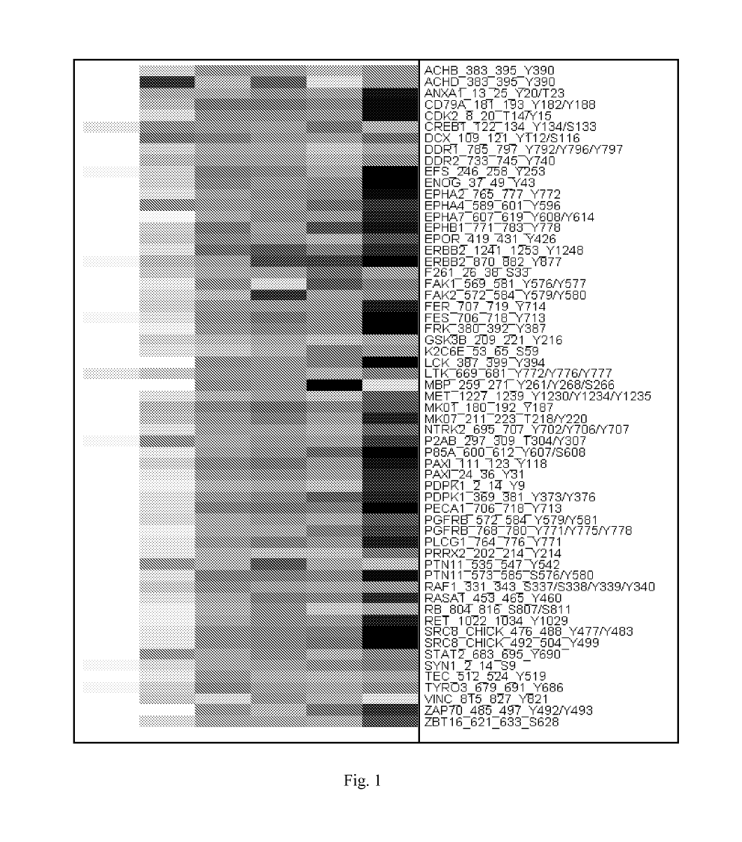

PAMCHIPS can also be used to profile and differentiate compounds. Five tyrosine kinase inhibitors (from left to right: DMSO, lapatinib/Tykerb, MTKI1/MTKI, gefitinib/Iressa, erlotinib/Tarceva, ZD6474/zactima) result in a distinct inhibition profile in lysates prepared from the responsive cell line NCI-H3255. Likewise, profiles have been generated from less responsive cell lines to differentiate compounds. Results are represented in FIG. 1

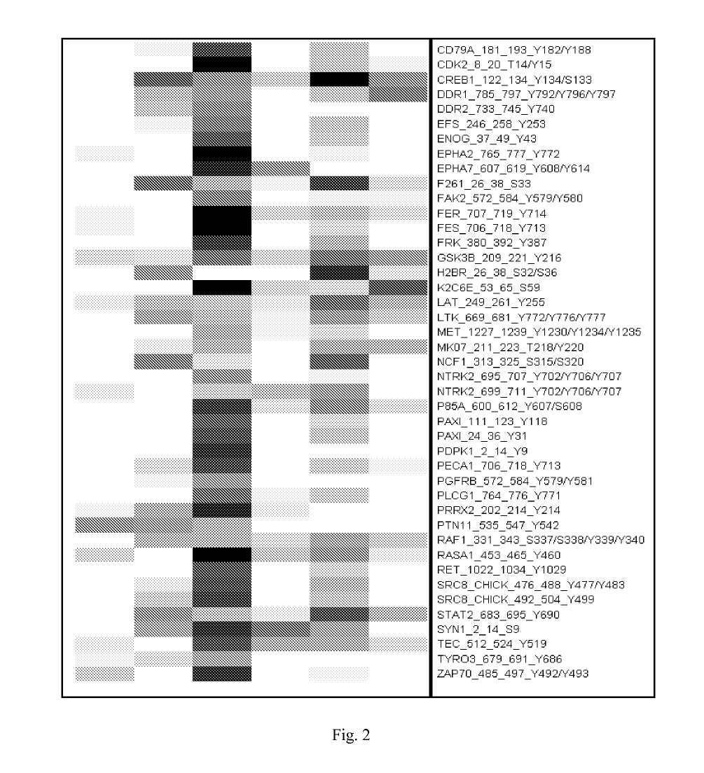

It was found that also non-kinase inhibitors can have profound effects on the PAMCHIP profile, when lysates are prepared from compound treated cells. An example is given where either a histone deacetylase inhibitor or MTKI1 is applied on DU-145 prostate cancer cells at 5 μM for 20 hours. A robust effect of the histone deacetylase inhibitor is observed on the PAMCHIP profile after cellular treatment, whereas little effect can be seen when lysates are treated with a histone deacetylase inhibitor, consistent with the idea that this compound indirectly inhibits kinases in a cellular context. This illustrates that any compound, when applied to cells, can potentially be profiled using PAMCHIPS. Results are represented in FIG. 2.

### Example 5

### Design of a Novel 256-Peptide Array-Generation of Signature Peptides in Xenograft Tumors for MTKI

To improve the specificity of the standard 140 peptide array and therefore the ability of peptide sets to discriminate between responders and non-responders, a novel set of 256 peptides was selected. The following strategy was used: first, phosphotyrosine peptides were identified in lysates of two cancer cell lines, DU145 and NCI-N87, by mass spectrometry (in collaboration with Cell Signalling Technologies). This yielded 937 phosphopeptides, many of which were never described earlier. 63 peptides of particular interest were added: known autophosphorylation sites or other substrates of tyrosine kinases that were underrepresented in the 937 peptides. All of these 1000 peptides were then synthesized using the SPOT methodology (a fast, cost-effective peptide synthesis procedure by JPT, Berlin, Germany), and spotted on 7 different 144 peptide arrays.

These arrays were incubated with 32 different cell line and tumor lysates, in the absence and presence of MTKI. From these peptides 194 peptides were selected based on (a) detectability in at least one of the lysates, (b) differential phosphorylation rates across the lysates, and (c) differential inhibition by MTKI in various lysates. In addition 62 peptides were added from the standard 140-peptide array that were found useful in previous experiments (such as those in Examples 1 to 4). The selected 256 peptides were then synthesized using standard high quality procedures by JPT (custom synthesis) and spotted as a single array by Pamgene. This new array (256-peptides) was used to profile 12 xenograft tumor lysates as before in the absence or presence of MTKI. The same mixed-model statistical analysis as before was used to select peptides that discriminate responder versus non-responder tumors. Results of that analysis are shown in Example 5 (28 peptides with P value <0.1). The fold inhibition of many of these peptides by MTKI is higher compared to the peptides selected from the 140 peptide array (see Example 2), indicating that these peptides are indeed more selective for certain MTKI target kinases. Most importantly, prediction accuracy is greatly improved compared to the peptide set derived from the 140-peptide set, illustrating the usefulness of the peptide selection strategy described above.

Results are shown in Tables 5A and B

Ratio of initial velocity of peptide phosphorylation in the presence of solvent (DMSO) over the initial velocity of peptide phosphorylation in the presence of MTKI; ′NaN indicates that there is no detectable phosphorylation in the presence of DMSO

TABLE 5A

| | H3255 | A431 | H322 | DU145 | SUM149 | BT474 |
|---|---|---|---|---|---|---|
| Peptides | MTKI | MTKI | MTKI | MTKI | MTKI | MTKI |
| ABLIM1_350_364_Y357 | 0.82 | 0.57 | 0.72 | 0.81 | 0.49 | 0.71 |
| ACHB_383_395_Y390 | 0.05 | 0.35 | 0.29 | 0.01 | 0.68 | 0.67 |
| C11orf35_217_231_Y224 | 0.14 | 0.36 | 0.05 | NaN | 0.75 | 0.80 |
| CBL_667_681_Y674 | 0.80 | 0.48 | 0.65 | 0.72 | 0.02 | 0.18 |
| CFL1_61_75_Y68 | 0.55 | 0.36 | 0.63 | 0.60 | 0.04 | 0.07 |
| DOK1_402_416_Y409 | 0.72 | 0.32 | 0.80 | 0.74 | 0.52 | 0.83 |
| BCAR1_380_394_Y387 | 0.11 | 0.13 | 0.74 | 0.51 | 0.05 | 0.82 |
| EPHB3_607_621_Y614 | 0.60 | 0.88 | 0.65 | 0.73 | 0.19 | 0.13 |
| FGFR1OP_330_344_Y337 | 0.65 | 0.96 | 1.04 | 0.97 | 0.51 | 0.94 |
| FKS | 0.71 | 0.55 | 0.68 | 0.69 | 0.11 | 0.12 |
| FYN_206_220_Y213 | 0.28 | 0.51 | 0.29 | 0.05 | 1.24 | 0.66 |
| KIRREL_550_564_Y557 | 0.22 | 0.78 | 0.69 | 0.63 | NaN | 0.17 |
| LAT_249_261_Y255 | 0.50 | 0.83 | 0.82 | 0.88 | 0.09 | 1.12 |
| LPHN2_1343_1357_Y1350 | 0.83 | 0.87 | 0.70 | 0.75 | 0.10 | 0.47 |
| LYN_186_200_Y193 | 0.28 | 0.08 | 0.38 | 0.13 | 0.06 | 0.69 |
| MAPK8_178_192_Y185 | 0.29 | 0.41 | 0.27 | 0.02 | 0.74 | 0.62 |
| MCP_362_376_Y369 | 1.04 | 0.11 | 0.61 | 0.76 | 0.04 | 0.25 |
| MET_1227_1239_Y1230/ | 0.72 | 0.99 | 0.66 | 0.43 | 0.08 | 0.53 |
| Y1234/Y1235 | | | | | | |
| NPT2_501_513_T508 | 0.55 | 0.66 | 0.22 | 0.05 | 0.92 | 0.87 |
| NAPG_298_312_Y307 | 0.59 | 0.75 | 0.79 | 0.74 | 0.26 | 0.69 |
| NCF1_313_325_S315/S320 | 0.47 | 0.57 | 0.22 | 0.10 | 0.80 | 0.93 |
| P2RY2_223_237_Y230 | 0.39 | 0.68 | 0.41 | 0.50 | 0.93 | 0.96 |
| P85A_600_612_Y607/S608 | 0.34 | 0.68 | 0.74 | 0.73 | 0.21 | 0.73 |
| RBM3_120_134_Y127 | 0.39 | 0.71 | 0.58 | 0.36 | 1.01 | 0.99 |
| SF3A3_472_486_Y479 | NaN | NaN | 0.85 | 0.33 | NaN | 0.53 |
| SHB_326_340_Y333 | 0.17 | 0.28 | 0.93 | 0.72 | NaN | 0.49 |
| SLC20A2_370_384_Y377 | 0.14 | 0.53 | 0.20 | 0.05 | 0.84 | 0.81 |
| VEGFR2_944_956_Y951 | 0.12 | 0.49 | 0.22 | 0.11 | 1.55 | 0.81 |
| response status | R | R | R | R | R | R |
| response prediction | R | R | R | R | R | R |

TABLE 5B

| | SKOV3 | U87MG | PC3 | H460 | H441 | HT29 |
|---|---|---|---|---|---|---|
| Peptides | MTKI | MTKI | MTKI | MTKI | MTKI | MTKI |
| ABLIM1_350_364_Y357 | 0.79 | 0.73 | 0.71 | 0.87 | 0.70 | 0.79 |
| ACHB_383_395_Y390 | 0.53 | 0.32 | 0.42 | NaN | 0.60 | 0.55 |
| C11orf35_217_231_Y224 | 0.83 | 0.67 | 0.56 | NaN | 0.36 | 0.73 |
| CBL_667_681_Y674 | 0.48 | 0.50 | 0.82 | 0.68 | 0.55 | 0.71 |
| CFL1_61_75_Y68 | 0.52 | 0.52 | 0.71 | 0.67 | 0.46 | 0.63 |
| DOK1_402_416_Y409 | 0.68 | 0.81 | 0.85 | 0.77 | 0.72 | 0.97 |
| BCAR1_380_394_Y387 | 0.57 | 0.45 | 0.68 | 0.85 | 0.68 | 0.73 |
| EPHB3_607_621_Y614 | 0.67 | 0.72 | 0.83 | 0.66 | 0.63 | 0.63 |
| FGFR1OP_330_344_Y337 | 0.98 | 1.14 | 0.90 | 0.91 | 0.90 | 0.91 |
| FKS | 0.59 | 0.66 | 0.75 | 0.71 | 0.54 | 0.69 |
| FYN_206_220_Y213 | 0.83 | 0.61 | 0.40 | NaN | 0.73 | 0.52 |
| KIRREL_550_564_Y557 | 0.91 | 0.54 | 0.78 | 0.72 | 0.56 | 0.69 |
| LAT_249_261_Y255 | 0.78 | 1.09 | 0.96 | 0.71 | 0.93 | 0.87 |
| LPHN2_1343_1357_Y1350 | 0.77 | 0.69 | 0.80 | 0.72 | 0.64 | 0.73 |
| LYN_186_200_Y193 | 0.49 | 0.48 | 0.76 | NaN | 0.57 | 0.78 |
| MAPK8_178_192_Y185 | 0.54 | 0.54 | 0.47 | NaN | 0.37 | 0.61 |
| MCP_362_376_Y369 | 0.65 | 0.71 | 0.83 | 0.67 | 0.55 | 0.64 |
| MET_1227_1239_Y1230/ | 0.78 | 0.64 | 0.81 | 0.67 | 0.64 | 0.90 |
| Y1234/Y1235 | | | | | | |
| NPT2_501_513_T508 | 0.91 | 0.82 | 0.59 | 0.92 | 0.82 | 0.75 |
| NAPG_298_312_Y307 | 0.73 | 0.88 | 0.80 | 0.70 | 0.79 | 0.73 |
| NCF1_313_325_S315/S320 | 0.85 | 0.77 | 0.44 | 0.73 | 0.83 | 0.60 |
| P2RY2_223_237_Y230 | 0.92 | 0.87 | 0.79 | 0.85 | 0.80 | 0.64 |
| P85A_600_612_Y607/S608 | 0.63 | 1.01 | 0.85 | 0.73 | 0.76 | 0.72 |
| RBM3_120_134_Y127 | 0.86 | 0.76 | 0.60 | 0.89 | 0.72 | 0.71 |
| SF3A3_472_486_Y479 | 0.48 | 1.08 | 1.20 | 0.47 | 0.93 | 0.96 |
| SHB_326_340_Y333 | 0.96 | 0.83 | 0.92 | 0.68 | 0.87 | 1.16 |
| SLC20A2_370_384_Y377 | 0.88 | 0.95 | 0.49 | 0.63 | 0.76 | 0.59 |
| VEGFR2_944_956_Y951 | 0.63 | 0.76 | 0.69 | NaN | 0.77 | 0.36 |
| response status | NR | NR | NR | NR | NR | NR |
| response prediction | NR | NR | NR | NR | NR | NR |

R = Responder to MTKI
NR = Non-Responder to MTKI
A Responder is predicted when minimally 14 peptides have a ratio <0.7 (indicated in bold font).
Overall accuracy: 100%

### Example 6

### MTKI-Derived Signature Peptides can Also be Used to Predict Response to other EGFR inhibitors, such as Tarceva (Erlotinib)

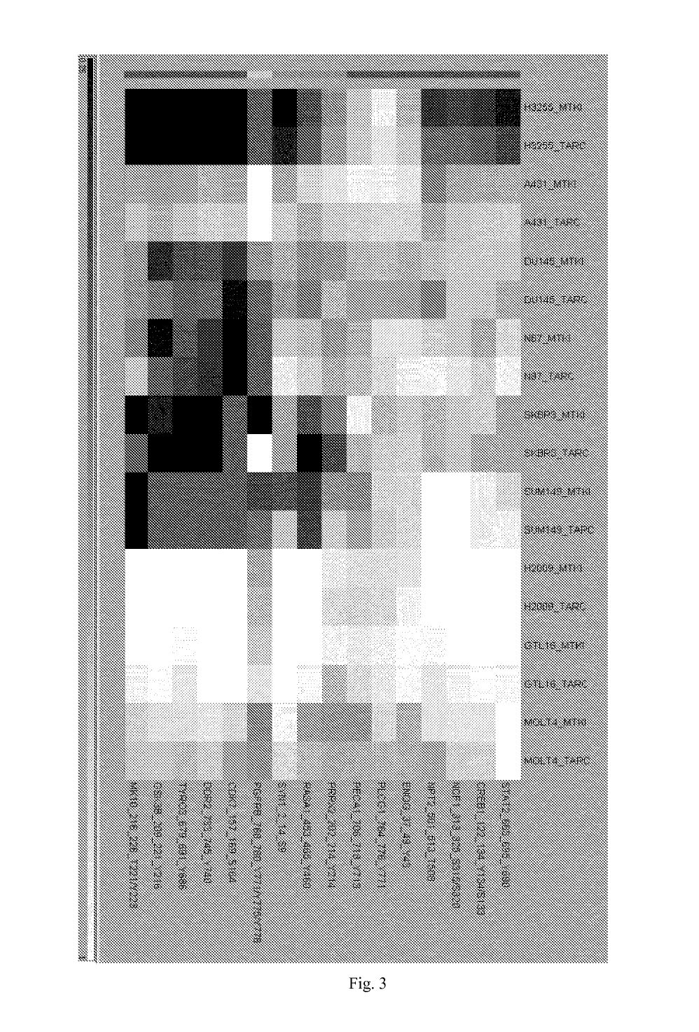

To test whether other EGFR inhibitors, related to MTKI, such as Tarceva (erlotinib; OSI pharmaceuticals), are also amenable to this response prediction methodology, 9 cell lines were profiled in the presence of MTKI, or Tarceva (5 μM in both cases). Although minor differences are detectable in the MTKI and Tarceva profiles (e.g. MTKI is slightly more potent on H3255, consistent with a lower IC50 on EGFR 1858R compared to Tarceva; MTKI is also more potent on N87, a cell line largely driven by Her2, for which MTKI is a better inhibitor than Tarceva; on the other hand Tarceva has additional activity in GTL16 lysates compared to MTKI, for unknown reasons), overall there is a striking resemblance in the inhibition pattern between MTKI and Tarceva (see FIG. 3). The value of the previously derived MTKI prediction peptides is illustrated in Tables 6A to C. Based on these peptides also response to Tarceva can be predicted with identical accuracy as for MTKI (and with the same false predictions, in casu H2009 and MOLT4). These results illustrate that the 16 peptides that correlate with response to MTKI likely also predict response to other EGFR inhibitors, such as Tarceva (erlotinib), or Iressa (gefitinib; AstraZeneca).

Ratio of initial velocity of peptide phosphorylation in the presence of solvent (DMSO) over the initial velocity of peptide phosphorylation in the presence of MTKI or Tarceva; ′NaN indicates that there is no detectable phosphorylation in the presence of DMSO.

TABLE 6A

| | H3255 | | A431 | | | DU145 |
|---|---|---|---|---|---|---|
| Peptides | MTKI | TARC | MTKI | TARC | MTKI | TARC |
| CDK7_157_169_S164 | 0.04 | 0.12 | 0.70 | 0.80 | 0.36 | 0.26 |
| CREB1_122_134_Y134/S133 | 0.35 | 0.46 | 0.71 | 0.81 | 0.80 | 0.78 |
| DDR2_733_745_Y740 | 0.13 | 0.18 | 0.73 | 0.83 | 0.44 | 0.50 |
| ENOG_37_49_Y43 | 0.74 | 0.80 | 0.91 | 0.84 | 0.72 | 0.67 |
| GSK3B_209_221_Y216 | 0.10 | 0.16 | 0.67 | 0.72 | 0.33 | 0.55 |
| MK10_216_228_T221/Y223 | 0.16 | 0.19 | 0.70 | 0.78 | 0.65 | 0.63 |
| NCF1_313_325_S315/S320 | 0.39 | 0.50 | 0.70 | 0.78 | 0.80 | 0.79 |
| NPT2_501_513_T508 | 0.35 | 0.50 | 0.58 | 0.70 | 0.76 | 0.57 |
| PECA1_706_718_Y713 | 0.78 | 0.80 | 0.96 | 0.82 | 0.74 | 0.68 |
| PGFRB_768_780_Y771/Y775/Y778 | NaN | NaN | 1.15 | 1.00 | 0.64 | 0.49 |
| PLCG1_764_776_Y771 | 0.95 | 0.90 | 0.94 | 0.84 | 0.76 | 0.69 |
| PRRX2_202_214_Y214 | 0.62 | 0.66 | 0.90 | 0.80 | 0.64 | 0.75 |
| RASA1_453_465_Y460 | 0.42 | 0.47 | 0.84 | 0.72 | 0.62 | 0.56 |
| STAT2_683_695_Y690 | 0.28 | 0.39 | 0.72 | 0.82 | 0.79 | 0.71 |
| SYN1_2_14_S9 | 0.25 | 0.30 | 0.71 | 0.81 | 0.72 | 0.65 |
| TYRO3_679_691_Y686 | 0.12 | 0.17 | 0.68 | 0.78 | 0.42 | 0.48 |
| response status | R | R | R | R | R | R |
| response prediction | R | R | R | R | R | R |

TABLE 6B

| | N87 | | SKBR3 | | SUM149 | |
|---|---|---|---|---|---|---|
| Peptides | MTKI | TARC | MTKI | TARC | MTKI | TARC |
| CDK7_157_169_S164 | 0.05 | 0.04 | NaN | NaN | NaN | NaN |
| CREB1_122_134_Y134/S133 | 0.71 | 0.82 | 0.82 | 0.70 | 0.94 | 0.94 |
| DDR2_733_745_Y740 | 0.36 | 0.34 | 0.03 | 0.02 | NaN | NaN |
| ENOG_37_49_Y43 | 0.89 | 0.95 | 0.80 | 0.82 | 0.85 | 0.86 |
| GSK3B_209_221_Y216 | 0.26 | 0.46 | 0.30 | 0.21 | NaN | NaN |
| MK10_216_228_T221/Y223 | 0.58 | 0.78 | 0.21 | 0.47 | 0.03 | 0.07 |
| NCF1_313_325_S315/S320 | 0.79 | 0.91 | 0.79 | 0.78 | 1.05 | 1.18 |
| NPT2_501_513_T508 | 0.82 | 0.96 | 0.75 | 0.74 | 1.11 | 1.34 |
| PECA1_706_718_Y713 | 0.73 | 0.76 | 0.96 | 0.74 | 0.60 | 0.68 |
| PGFRB_768_780_Y771/Y775/Y778 | NaN | NaN | 0.09 | 1.63 | 0.40 | 0.52 |
| PLCG1_764_776_Y771 | 0.89 | 0.86 | 0.74 | 0.81 | 0.84 | 0.80 |
| PRRX2_202_214_Y214 | 0.65 | 0.72 | 0.57 | 0.41 | 0.62 | 0.80 |
| RASA1_453_465_Y460 | 0.76 | 0.83 | 0.42 | 0.23 | 0.37 | 0.39 |
| STAT2_683_695_Y690 | 0.85 | 0.95 | 0.69 | 0.70 | 0.85 | 0.95 |
| SYN1_2_14_S9 | 0.79 | 0.93 | 0.69 | 0.67 | 0.43 | 0.78 |
| TYRO3_679_691_Y686 | 0.44 | 0.40 | 0.05 | 0.04 | NaN | NaN |
| response status | R | R | R | R | R | R |
| response prediction | R | R | R | R | R | R |

TABLE 6C

| | H2009 | | GTL16 | | MOLT4 | |
|---|---|---|---|---|---|---|
| Peptides | MTKI | TARC | MTKI | TARC | MTKI | TARC |
| CDK7_157_169_S164 | 1.22 | 1.28 | 1.04 | 1.06 | 0.85 | 0.68 |
| CREB1_122_134_Y134/S133 | 1.16 | 1.13 | 1.09 | 0.99 | 0.90 | 0.83 |
| DDR2_733_745_Y740 | 1.15 | 1.08 | 1.08 | 1.01 | 0.91 | 0.81 |
| ENOG_37_49_Y43 | 0.90 | 0.96 | 0.99 | 0.98 | 0.73 | 0.72 |
| GSK3B_209_221_Y216 | 1.09 | 1.15 | 1.00 | 0.99 | 0.88 | 0.79 |
| MK10_216_228_T221/Y223 | 1.14 | 1.16 | 1.03 | 0.96 | 0.82 | 0.78 |
| NCF1_313_325_S315/S320 | 1.10 | 1.07 | 1.03 | 0.96 | 0.91 | 0.82 |
| NPT2_501_513_T508 | 1.08 | 1.03 | 0.98 | 0.91 | 0.89 | 0.69 |
| PECA1_706_718_Y713 | 0.88 | 0.84 | 0.92 | 0.86 | 0.64 | 0.72 |
| PGFRB_768_780_Y771/Y775/Y778 | 0.71 | 0.75 | 0.80 | 0.89 | 0.60 | 0.63 |
| PLCG1_764_776_Y771 | 0.87 | 0.86 | 0.95 | 0.92 | 0.85 | 0.74 |
| PRRX2_202_214_Y214 | 0.92 | 0.86 | 0.96 | 0.75 | 0.64 | 0.71 |
| RASA1_453_465_Y460 | 1.01 | 1.00 | 1.04 | 0.98 | 0.67 | 0.75 |
| STAT2_683_695_Y690 | 1.17 | 1.12 | 1.02 | 0.97 | 1.11 | 1.06 |
| SYN1_2_14_S9 | 1.17 | 1.17 | 1.07 | 1.02 | 0.97 | 0.86 |
| TYRO3_679_691_Y686 | 1.10 | 1.03 | 0.99 | 0.91 | 0.88 | 0.76 |
| response status | R | R | NR | NR | NR | NR |
| response prediction | NR | NR | NR | NR | R | R |

A responder is predicted when minimally 4 peptides <0.8
MTKI: Accuracy: 78% (7/9); Sensitivity: 86% (6/7); Specificity: 50% (1/2)
Tarceva: Accuracy: 78% (7/9); Sensitivity: 86% (6/7); Specificity: 50% (1/2)

### Example 7

### Inhibition of cMet in Cell Lysates can be Correlated to a Specific Peptide Set

To examine whether the currently available 140-tyrosine peptide arrays from Pamgene will also detect other kinase activities then those described above, another compound was profiled using the same methodology: this is an exquisitely selective inhibitor of the cMET receptor tyrosine kinase (see US2007 0203136 A1) and with formula:

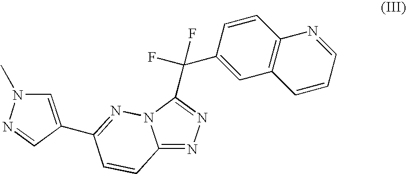

Similarly, a range of cell lines with varying responsiveness to the cMET inhibitor 605 in HGF-induced colony formation, were profiled (in this case 1 μM compound was sufficient for significant inhibition of peptide phosphorylation in the responder cell lysates). As shown in Example 7, clear-cut differences in peptide phosphorylation inhibition by 605 could be identified in the responder lysates versus non-responder lysates. Note that the cMet signature peptide set features two peptides derived from Ron, the closest homologue to cMet. 605 does not inhibit purified Ron kinase at 1 μM at all. However, these Ron sites have been demonstrated to be targets for phosphorylation by cMet (Follenzi et al., 2000, Oncogene 19, 4041-3049). The 605 signature peptides show no overlap at all with the MTKI signature peptides set, consistent with the absence of any overlap in kinase specificity between MTKI and 605. These data illustrate that for two types of tyrosine kinase inhibitors, the multi-targeted EGFR inhibitor, MTKI (and Tarceva), and the selective cMET inhibitor, 605, specific peptides can be identified of which the compound mediated inhibition of phosphorylation rates in sample lysates predict actual biological response of these samples to the compounds using the herein described methodology. Results are shown in Tables 7A to C.

TABLE 7A

| | MKN45 | SNU5 | Kato2 | H441 | H1792 |
|---|---|---|---|---|---|
| Peptides | 605 | 605 | 605 | 605 | 605 |
| ANXA1_13_25_Y20/T23 | 0.03 | 0.06 | 0.27 | 0.22 | 1.16 |
| CALM_95_107_Y99/S101 | 0.14 | 0.03 | 0.11 | 0.14 | 0.53 |
| EPHA4_589_601_Y596 | 0.27 | 0.26 | 0.29 | 0.32 | 0.77 |
| EGFR_1165_1177_Y1172 | 0.22 | 0.02 | 0.10 | 0.43 | 0.33 |
| FAK2_572_584_Y579/Y580 | 0.57 | 0.38 | 0.45 | 0.56 | 0.86 |
| FGFR1_759_771_Y766 | 0.10 | 0.04 | 0.01 | 0.01 | NaN |
| JAK1_1015_1027_Y1022/Y1023 | 0.07 | 0.03 | 0.18 | 0.02 | 0.96 |
| LAT_194_206_Y200 | 0.11 | 0.04 | 0.07 | 0.16 | 0.04 |
| LAT_249_261_Y255 | 0.59 | 0.26 | 0.64 | 0.71 | 1.04 |
| LCK_387_399_Y394 | 0.01 | 0.01 | 0.01 | NaN | NaN |
| MK07_211_223_T218/Y220 | 0.41 | 0.29 | 0.31 | 0.37 | 0.85 |
| NTRK2_699_711_Y702/Y706/Y707 | 0.64 | 0.43 | 0.42 | 0.54 | 0.86 |
| PDPK1_2_14_Y9 | 0.56 | 0.35 | 0.37 | 0.39 | 0.93 |
| PDPK1_369_381_Y373/Y376 | 0.36 | 0.10 | 0.27 | 0.23 | 0.84 |
| PGFRB_1002_1014_Y1009 | 0.19 | 0.13 | 0.05 | 0.02 | 1.05 |
| PGFRB_709_721_Y716 | 0.46 | 0.25 | 0.21 | 0.36 | 1.01 |
| PRRX2_202_214_Y214 | 0.44 | 0.28 | 0.27 | 0.33 | 0.81 |
| VEGFR2_1052_1064_Y1059 | 0.02 | 0.04 | 0.03 | 0.05 | 0.84 |
| RON_1346_1358_Y1353 | 0.12 | 0.06 | 0.08 | 0.05 | 0.71 |
| RON_1353_1365_Y1356/Y1360 | 0.04 | 0.16 | 0.17 | 0.07 | NaN |
| KSYK_518_530_Y525/Y526 | 0.26 | 0.20 | 0.14 | 0.22 | 0.79 |
| VINC_815_827_Y821 | 0.55 | 0.36 | 0.34 | 0.49 | 0.79 |
| response status | R | R | R | R | R |
| response prediction | R | R | R | R | R |

TABLE 7B

| | WIDR | A549 | YKG | N87 | Caco2 |
|---|---|---|---|---|---|
| Peptides | 605 | 605 | 605 | 605 | 605 |
| ANXA1_13_25_Y20/T23 | 0.49 | 0.92 | NaN | 0.77 | NaN |
| CALM_95_107_Y99/S101 | 0.31 | NaN | NaN | 0.12 | NaN |
| EPHA4_589_601_Y596 | 0.59 | 1.08 | 1.36 | 0.88 | 0.75 |
| EGFR_1165_1177_Y1172 | 0.85 | 1.34 | NaN | 0.86 | NaN |
| FAK2_572_584_Y579/Y580 | 0.91 | 0.90 | 0.92 | 0.97 | 1.05 |
| FGFR1_759_771_Y766 | NaN | NaN | NaN | NaN | NaN |
| JAK1_1015_1027_Y1022/Y1023 | 0.39 | 1.91 | NaN | NaN | NaN |
| LAT_194_206_Y200 | 0.86 | NaN | NaN | 0.63 | NaN |
| LAT_249_261_Y255 | 1.02 | 1.24 | 0.69 | 0.91 | NaN |
| LCK_387_399_Y394 | NaN | NaN | NaN | NaN | NaN |
| MK07_211_223_T218/Y220 | 0.87 | 0.97 | 0.79 | 1.06 | 0.80 |
| NTRK2_699_711_Y702/Y706/Y707 | 0.88 | 0.95 | 1.09 | 0.96 | 0.92 |
| PDPK1_2_14_Y9 | 0.85 | 1.02 | 1.00 | 0.70 | 0.77 |
| PDPK1_369_381_Y373/Y376 | 0.65 | 1.12 | NaN | 0.59 | NaN |
| PGFRB_1002_1014_Y1009 | NaN | NaN | NaN | NaN | NaN |
| PGFRB_709_721_Y716 | 0.71 | 1.10 | NaN | 0.78 | NaN |
| PRRX2_202_214_Y214 | 0.74 | 0.84 | 1.23 | 0.78 | 0.83 |
| VEGFR2_1052_1064_Y1059 | 0.54 | 0.81 | NaN | 0.68 | NaN |
| RON_1346_1358_Y1353 | 0.12 | 0.37 | NaN | NaN | NaN |
| RON_1353_1365_Y1356/Y1360 | 0.04 | NaN | NaN | NaN | NaN |
| KSYK_518_530_Y525/Y526 | 0.81 | 1.16 | 0.46 | 1.02 | 0.95 |
| VINC_815_827_Y821 | 0.71 | 0.81 | 1.13 | 0.96 | 0.89 |
| response status | R | NR | NR | NR | NR |
| response prediction | R | NR | NR | R | NR |

TABLE 7C

| | H322 | SNU484 | H2122 | H2106 |
|---|---|---|---|---|
| Peptides | 605 | 605 | 605 | 605 |
| ANXA1_13_25_Y20/T23 | 1.08 | NaN | 1.04 | 0.69 |
| CALM_95_107_Y99/S101 | NaN | NaN | 0.49 | 0.14 |
| EPHA4_589_601_Y596 | 0.82 | 0.87 | 1.10 | 2.26 |
| EGFR_1165_1177_Y1172 | 1.43 | 0.86 | 1.06 | 1.01 |
| FAK2_572_584_Y579/Y580 | 1.06 | 0.91 | 1.07 | 1.10 |
| FGFR1_759_771_Y766 | NaN | NaN | 1.05 | NaN |
| JAK1_1015_1027_Y1022/Y1023 | 1.25 | NaN | 0.96 | 0.72 |
| LAT_194_206_Y200 | 0.65 | NaN | 0.71 | NaN |
| LAT_249_261_Y255 | 1.23 | 1.17 | 0.98 | 0.97 |
| LCK_387_399_Y394 | NaN | NaN | NaN | NaN |
| MK07_211_223_T218/Y220 | 0.90 | 1.02 | 0.98 | 0.90 |
| NTRK2_699_711_Y702/ | 1.01 | 0.97 | 1.03 | 1.12 |
| Y706/Y707 | | | | |
| PDPK1_2_14_Y9 | 1.02 | 0.96 | 0.94 | 0.99 |
| PDPK1_369_381_Y373/Y376 | 1.11 | 0.66 | 1.10 | 0.98 |
| PGFRB_1002_1014_Y1009 | NaN | NaN | 0.85 | 0.41 |
| PGFRB_709_721_Y716 | 0.92 | 0.69 | 1.02 | 0.67 |
| PRRX2_202_214_Y214 | 0.93 | 0.90 | 1.33 | 1.08 |
| VEGFR2_1052_1064_Y1059 | NaN | 0.59 | 1.02 | 0.96 |
| RON_1346_1358_Y1353 | NaN | NaN | 0.17 | NaN |
| RON_1353_1365_Y1356/Y1360 | NaN | NaN | 0.08 | NaN |
| KSYK_518_530_Y525/Y526 | 1.08 | 1.03 | 1.46 | 0.85 |
| VINC_815_827_Y821 | 0.89 | 0.76 | 1.44 | 1.00 |
| response status | NR | NR | NR | NR |
| response prediction | NR | NR | NR | NR |

R = Responder to cMET
NR = Non-Responder to cMET
A Responder is predicted when minimally 7 peptides have a ratio <0.8 (indicated in bold font).
overall prediction accuracy: 12/13 (92%)
sensitivity (number of predicted Responders over number of actual Responders): 6/6 (100%)
specificity (number of predicted Non-Responders over number of actual Non-Responders): 7/8 (88%)

While the foregoing specification teaches the principles of the present invention, with examples provided for the purpose of illustration, it will be understood that the practice of the invention encompasses all of the usual variations, adaptations and/or modifications as come within the scope of the following claims and their equivalents.

1. A method for obtaining a pharmacological profile of a kinase inhibitor using a first and a second array of substrates immobilized on a porous matrix, said method comprising the subsequent steps of;
(i) preparing a cell lysate from a cell line, including cancer cell lines; primary and immortalized tissue cell lines; non-human animal model biopsies and patient biopsies;
(ii) filtering said cell lysate over a filter in the 10 to 0.1 micrometer range to obtain a filtered cell lysate;
(iii) contacting said first array of substrates in the presence of the kinase inhibitor with a first fraction of said filtered cell lysate and determining the response of said first array
(iv) contacting said second array of substrates in the absence of the kinase inhibitor with a second fraction of said filtered cell lysate and determining the response of said second array; and
obtaining the pharmacological profile as the ratio of the array substrate response in step (iii) over the array substrate response in step (iv).

2. The method as in claim 1, wherein said substrates are selected from the group consisting of hormone receptors, peptides, enzymes, oligonucleotides, monoclonal antibodies, haptens and aptamers.

3. The method as in claim 1, wherein said substrates are kinase substrates.

4. The method as in claim 1, wherein said substrates are peptide kinase substrates.

5. The method as in claim 1, wherein said substrates are at least two peptide kinase substrates selected from the group consisting of the peptide kinase substrates with sequence numbers 1 to 337.

6. The method of claim 5, wherein said substrates consist of the peptide kinase substrates with sequence numbers 15, 16, 22, 34, 62, 83, 86, 87, 100, 105, 108, 110, 113, 125, 129, and 133.

7. The method of claim 5, wherein said substrates consist of the peptide kinase substrates with sequence numbers 15, 16, 21, 23, 38, 42, 53, 62, 69, 77, 83, 86, 91, 94, 103, 112, 114, 129, 133, 136 and 138.

8. The method of claim 5, wherein said substrates consist of the peptide kinase substrates with sequence numbers 142, 2, 163, 173, 177, 190, 161, 197, 207, 208, 213, 241, 73, 252, 255, 258, 262, 79, 87, 266, 86, 269, 95, 296, 303, 305, 308, and 138.

9. The method of claim 5, wherein said substrates consist of the peptide kinase substrates with sequence numbers 5, 10, 38, 30, 54, 57, 68, 72, 73, 74, 82, 91, 98, 99, 102, 104, 110, 135, 118, 119, 71, 138.

10. The method as in claim 1, wherein the cell lysate is prepared from a cancer cell line; xenograft tumor or cancer patient biopsy, including tumor and normal tissue.

11. A method as in claim 1, wherein the response of the array of substrates is determined using a detectable signal, said signal resulting from the interaction of the sample with the array of substrates.

12. A method as claimed in claim 1 wherein the response of the array of substrates to the sample is determined using detectably labeled antibodies.

13. A method as claimed in claim 12 wherein the response of the array of substrates is determined using fluorescently labeled anti-phosphotyrosine antibodies.

14. Use of the pharmacological profile determined according to the method of claim 1, to enable the distinction between responders and non-responders in the treatment of cells, tissues, organs or warm-blooded animals for a kinase inhibitor.

15. Use according to claim 14, wherein the kinase inhibitor to be tested is selected from the group consisting of MTKI1, 605 and erlotinib.

16. Use according to claim 14 wherein pharmacological profile is determined using an array of substrates comprising at least 2 peptides selected from the peptide kinase substrates with sequence numbers 15, 16, 22, 34, 62, 83, 86, 87, 100, 105, 108, 110, 113, 125, 129, and 133.

17. Use according to claim 14 wherein pharmacological profile is determined using an array of substrates comprising at least 2 peptides selected from the peptide kinase substrates with sequence numbers 15, 16, 21, 23, 38, 42, 53, 62, 69, 77, 83, 86, 91, 94, 103, 112, 114, 129, 133, 136 and 138.

18. Use according to claim 14 wherein pharmacological profile is determined using an array of substrates comprising at least 2 peptides selected from the peptide kinase substrates with sequence numbers 142, 2, 163, 173, 177, 190, 161, 197, 207, 208, 213, 241, 73, 252, 255, 258, 262, 79, 87, 266, 86, 269, 95, 296, 303, 305, 308, and 138.

19. Use according to claim 14 wherein pharmacological profile is determined using an array of substrates comprising at least 2 peptides selected from the peptide kinase substrates with sequence numbers 5, 10, 38, 30, 54, 57, 68, 72, 73, 74, 82, 91, 98, 99, 102, 104, 110, 135, 118, 119, 71, 138.

20. A method to enable the distinction of responders from non-responders cell lines and tumors to the treatment with 4,6-ethanediylidenepyrimido[4,5-b][6,1,12]benzoxadiazacyclopentadecine, 17-bromo-8,9,10,11,12,13,14,19-octahydro-20-methoxy-13-methyl-(MTKI 1); or the pharmaceutically acceptable acid or base addition salts thereof; or erlotinib, said method comprising;
(i) providing a sample from said cell lines and/or tumors;
(ii) contacting an array of substrates with said sample in the presence of MTKI1;
(iii) contacting an array of substrates with said sample in the absence of MTKI1;
(iv) determine the response of said array to the sample in step (ii);
(v) determine the response of said array to the sample in step (iii); and
obtain the pharmacological profile as the ratio in response of the array in steps (iv) over step (v); characterized in that the array of substrates comprises at least 2 peptides selected from the group consisting of the peptide kinase substrates with sequence numbers 15, 16, 22, 34, 62, 83, 86, 87, 100, 105, 108, 110, 113, 125, 129, and 133; and wherein a responder is identified as an inhibition (ratio<1.0) in response for at least two of the peptides selected from the peptide kinase substrates with sequence numbers 15, 16, 22, 34, 62, 83, 86, 87, 100, 105, 108, 110, 113, 125, 129, and 133.

21. A method according to claim 20 wherein a responder is identified as an inhibition in response (ratio at least <0.80) for at least two of the peptides selected from the group consisting of the peptide kinase substrates with sequence numbers 15, 16, 22, 34, 62, 83, 86, 87, 100, 105, 108, 110, 113, 125, 129, and 133.

22. A method according to claim 20 wherein the array of substrates comprising at least 3 peptides selected from the group consisting of the peptide kinase substrates with sequence numbers 15, 16, 22, 34, 62, 83, 86, 87, 100, 105, 108, 110, 113, 125, 129, and 133; in particular the array of substrates comprises the peptide kinase substrates with sequence numbers 15, 16, 22, 34, 62, 83, 86, 87, 100, 105, 108, 110, 113, 125, 129, and 133; more in particular the array of substrates consists of the peptide kinase substrates with sequence numbers 15, 16, 22, 34, 62, 83, 86, 87, 100, 105, 108, 110, 113, 125, 129, and 133.

23. A method to enable the distinction of responders from non-responders cell lines and tumors to the treatment with 4,6-ethanediylidenepyrimido[4,5-b][6,1,12]benzoxadiazacyclopentadecine, 17-bromo-8,9,10,11,12,13,14,19-octahydro-20-methoxy-13-methyl-(MTKI 1), erlotinib or 605; or the pharmaceutically acceptable acid or base addition salts thereof, said method comprising;
(i) providing a sample from said cell lines and/or tumors;
(ii) contacting an array of substrates with said sample in the presence of MTKI1, erlotinib or 605;
(iii) contacting an array of substrates with said sample in the absence of MTKI1, erlotinib or 605;
(iv) determine the response of said array to the sample in step (ii);
(v) determine the response of said array to the sample in step (iii); and
obtain the pharmacological profile as the ratio in response of the array in steps (iv) over step (v); characterized in that the array of substrates comprises at least 2 peptides selected from the group consisting of the peptide kinase substrates with sequence numbers 15, 16, 21, 23, 38, 42, 53, 62, 69, 77, 83, 86, 91, 94, 103, 112, 114, 129, 133, 136 and 138; and wherein a responder is identified as an inhibition (ratio<1.0) in response for at least two of the peptides selected from the peptide kinase substrates with sequence numbers 15, 16, 21, 23, 38, 42, 53, 62, 69, 77, 83, 86, 91, 94, 103, 112, 114, 129, 133, 136 and 138.

24. A method according to claim 23 wherein a responder is identified as an inhibition in response (ratio at least <0.80) for at least two of the peptides selected from the group consisting of the peptide kinase substrates with sequence numbers 15, 16, 21, 23, 38, 42, 53, 62, 69, 77, 83, 86, 91, 94, 103, 112, 114, 129, 133, 136 and 138.

25. method according to claim 23 wherein the array of substrates comprising at least 3 peptides selected from the group consisting of the peptide kinase substrates with sequence numbers 15, 16, 21, 23, 38, 42, 53, 62, 69, 77, 83, 86, 91, 94, 103, 112, 114, 129, 133, 136 and 138; in particular the array of substrates comprises the peptide kinase substrates with sequence numbers 15, 16, 21, 23, 38, 42, 53, 62, 69, 77, 83, 86, 91, 94, 103, 112, 114, 129, 133, 136 and 138; more in particular the array of substrates consists of the peptide kinase substrates with sequence numbers 15, 16, 21, 23, 38, 42, 53, 62, 69, 77, 83, 86, 91, 94, 103, 112, 114, 129, 133, 136 and 138.

26. A method to enable the distinction of responders from non-responders cell lines and tumors to the treatment with 4,6-ethanediylidenepyrimido[4,5-b][6,1,12]benzoxadiazacyclopentadecine, 17-bromo-8,9,10,11,12,13,14,19-octahydro-20-methoxy-13-methyl-(MTKI 1), erlotinib or 605 or the pharmaceutically acceptable acid or base addition salts thereof, said method comprising;
(i) providing a sample from said cell lines and/or tumors;
(ii) contacting an array of substrates with said sample in the presence of MTKI1, erlotinib or 605;
(iii) contacting an array of substrates with said sample in the absence of MTKI1, erlotinib or 605;
(iv) determine the response of said array to the sample in step (ii);
(v) determine the response of said array to the sample in step (iii); and
obtain the pharmacological profile as the ratio in response of the array in steps (iv) over step (v); characterized in that the array of substrates comprises at least 2 peptides selected from the group consisting of the peptide kinase substrates with sequence numbers 142, 2, 163, 173, 177, 190, 161, 197, 207, 208, 213, 241, 73, 252, 255, 258, 262, 79, 87, 266, 86, 269, 95, 296, 303, 305, 308, and 138; and wherein a responder is identified as an inhibition (ratio<1.0) in response for at least two of the peptides selected from the peptide kinase substrates with sequence numbers 142, 2, 163, 173, 177, 190, 161, 197, 207, 208, 213, 241, 73, 252, 255, 258, 262, 79, 87, 266, 86, 269, 95, 296, 303, 305, 308, and 138.

27. A method according to claim 26 wherein a responder is identified as an inhibition in response (ratio at least <0.80) for at least two of the peptides selected from the group consisting of the peptide kinase substrates with sequence numbers 142, 2, 163, 173, 177, 190, 161, 197, 207, 208, 213, 241, 73, 252, 255, 258, 262, 79, 87, 266, 86, 269, 95, 296, 303, 305, 308, and 138.

28. A method according to claim 26 wherein the array of substrates comprising at least 3 peptides selected from the group consisting of the peptide kinase substrates with sequence numbers 142, 2, 163, 173, 177, 190, 161, 197, 207, 208, 213, 241, 73, 252, 255, 258, 262, 79, 87, 266, 86, 269, 95, 296, 303, 305, 308, and 138; in particular the array of substrates comprises the peptide kinase substrates with sequence numbers 142, 2, 163, 173, 177, 190, 161, 197, 207, 208, 213, 241, 73, 252, 255, 258, 262, 79, 87, 266, 86, 269, 95, 296, 303, 305, 308, and 138 more in particular the array of substrates consists of the peptide kinase substrates with sequence numbers 142, 2, 163, 173, 177, 190, 161, 197, 207, 208, 213, 241, 73, 252, 255, 258, 262, 79, 87, 266, 86, 269, 95, 296, 303, 305, 308, and 138.

29. A method to enable the distinction of responders from non-responders cell lines and tumors to the treatment with; or the pharmaceutically acceptable acid or base addition salts thereof, said method comprising;
(i) providing a sample from said cell lines and/or tumors;
(ii) contacting an array of substrates with said sample in the presence of 605;
(iii) contacting an array of substrates with said sample in the absence of 605;
(iv) determine the response of said array to the sample in step (ii);
(v) determine the response of said array to the sample in step (iii); and
obtain the pharmacological profile as the ratio in response of the array in steps (iv) over step (v); characterized in that the array of substrates comprises at least 2 peptides selected from the group consisting of the peptide kinase substrates with sequence numbers 5, 10, 38, 30, 54, 57, 68, 72, 73, 74, 82, 91, 98, 99, 102, 104, 110, 135, 118, 119, 71, 138; and wherein a responder is identified as an inhibition (ratio<1.0) in response for at least two of the peptides selected from the peptide kinase substrates with sequence numbers 5, 10, 38, 30, 54, 57, 68, 72, 73, 74, 82, 91, 98, 99, 102, 104, 110, 135, 118, 119, 71, 138.

30. A method according to claim 26 wherein a responder is identified as an inhibition in response (ratio at least <0.80) for at least two of the peptides selected from the group consisting of the peptide kinase substrates with sequence numbers 5, 10, 38, 30, 54, 57, 68, 72, 73, 74, 82, 91, 98, 99, 102, 104, 110, 135, 118, 119, 71, 138.

31. A method according to claim 26 wherein the array of substrates comprising at least 3 peptides selected from the group consisting of the peptide kinase substrates with sequence numbers 5, 10, 38, 30, 54, 57, 68, 72, 73, 74, 82, 91, 98, 99, 102, 104, 110, 135, 118, 119, 71, 138; in particular the array of substrates comprises the peptide kinase substrates with sequence numbers 5, 10, 38, 30, 54, 57, 68, 72, 73, 74, 82, 91, 98, 99, 102, 104, 110, 135, 118, 119, 71, 138, more in particular the array of substrates consists of the peptide kinase substrates with sequence numbers 5, 10, 38, 30, 54, 57, 68, 72, 73, 74, 82, 91, 98, 99, 102, 104, 110, 135, 118, 119, 71, 138.

32. A method to claim 1, wherein the response of the array of substrates is determined using antibodies in a solution free of antifungals, in particular using an azide free solution.

33. An array of substrates comprising peptides selected from the group consisting of the peptide kinase substrates with sequence numbers 1 to 337, with the proviso that said array does not consist of peptide kinase substrates with sequence numbers 1-140.

34. An array of substrates as in claim 33, consisting of the peptide kinase substrates with sequence numbers 1 to 337.

35. An array of substrates as in claim 33, consisting of the peptide kinase substrates with sequence numbers 15, 16, 22, 34, 62, 83, 86, 87, 100, 105, 108, 110, 113, 125, 129, and 133.

36. An array of substrates as in claim 33, consisting of the peptide kinase substrates with sequence numbers 15, 16, 21, 23, 38, 42, 53, 62, 69, 77, 83, 86, 91, 94, 103, 112, 114, 129, 133, 136 and 138.

37. An array of substrates as in claim 33, consisting of the peptide kinase substrates with sequence numbers 142, 2, 163, 173, 177, 190, 161, 197, 207, 208, 213, 241, 73, 252, 255, 258, 262, 79, 87, 266, 86, 269, 95, 296, 303, 305, 308, and 138.

38. An array of substrates as in claim 33, consisting of the peptide kinase substrates with sequence numbers 5, 10, 38, 30, 54, 57, 68, 72, 73, 74, 82, 91, 98, 99, 102, 104, 110, 135, 118, 119, 71, 138.

39. A method for predicting possible kinase inhibitor response in a patient in the treatment of cancer, comprising the steps of:
(i) Preparing a cell lysate from a cancer patient biopsy, including normal and tumor tissue,
(ii) Contacting a first array of substrates as in claim 33 with a fraction of the cell lysate of step (i) in the presence of a kinase inhibitor;
(iii) Contacting a second array of substrates identical to said first array of substrates with a fraction of the cell lysate of step (i) in the absence of the kinase inhibitor; and
Obtaining a pharmacological profile for said patient as the ratio of the first array of substrates response over the second array of substrates response, wherein said pharmacological profile predicts said possible kinase inhibitor response.
